SEQUENCE LISTING (3 sequences)

SEQ ID NO: 1 - DNA, 50 bp, Artificial Sequence
  Description of Artificial Sequence Synthetic probe
agtcgagcggtagcacagagagcttgctctcgggtgacgagcggcggacg

SEQ ID NO: 2 - DNA, 20 bp, Artificial Sequence
  Description of Artificial Sequence Synthetic oligonucleotide
tttttttttttttttttttt

SEQ ID NO: 3 - DNA, 70 bp, Artificial Sequence
  Description of Artificial Sequence Synthetic oligonucleotide
aaaaaaaaaaaaaaaaaaaaagtcgagcggtagcacagagagcttgctctcgggtgacgagcggcggacg

(19) United States
(12) Patent Application Publication
(10) Pub. No.: US 2010/0009862 A1
(43) Pub. Date: Jan. 14, 2010

(54) BIOMOLECULE SENSOR, METHOD FOR MANUFACTURING THE SAME, BIOMOLECULE DETECTION METHOD, AND BIOMOLECULE DETECTION SYSTEM

(76) Inventors: Miwako NAKAHARA, Tokyo (JP); Takashi Inoue, Yokohama (JP); Osamu Kogi, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/023,309

(22) Filed: Jan. 31, 2008

(30) Foreign Application Priority Data
Feb. 2, 2007 (JP) 2007-024082

(51) Int. Cl. C40B 30/04; C40B 40/00; C40B 40/06; C40B 50/14; C40B 60/10

(52) U.S. Cl. 506/9; 506/13; 506/16; 506/30; 506/38

(57) ABSTRACT

The present invention aims to improve detecting accuracy and reproducibility of a biomolecule sensor. The biomolecule sensor of the present invention includes single probe molecules orderly aligned and fixed on grid points on the surface of a substrate. Accordingly, in the biomolecule sensor of the present invention: probe molecules for detecting a biomolecule are orderly aligned and separately fixed; blocking for preventing non-specific adsorption is applied to a region other than the region of the probe molecules for detecting a biomolecule; and fluorescence enhancement is achieved by metal microparticles.

### CLAIM OF PRIORITY

The present application claims priority from Japanese application JP 2007-24082 filed on Feb. 2, 2007, the content of which is hereby incorporated by reference into this application.

### BACKGROUND OF THE INVENTION

1. Field of the Invention

The present invention relates to a biomolecule sensor for detecting a biomolecule, a method for manufacturing a biomolecule sensor, a biomolecule detection method, and a biomolecule detection system.

2. Description of the Related Art

Having virtually completed the human genome deciphering, a large number of researchers have been actively conducting studies for elucidation of gene functions in recent years. In this research field where specific and exhaustive detection of genes and proteins in vivo is required, technological development for detection of genes and proteins has been extensively conducted all over the world. Meanwhile, techniques for identifying pathogens and viruses, which entered living organisms, at the gene and protein levels have also been investigated, and some techniques are about to be put into practical application. For such a purpose, a wide variety of biosensors have been used as a means for detecting specific biomolecules, such as genes and proteins. In the structure of the most commonly-used biosensor, probe molecules for capturing biomolecules are fixed on the surface of a solid. A nucleic acid is generally used as a probe molecule for capturing a nucleic acid, while a protein is generally used as a probe molecule for capturing a protein. A biosensor having probe molecules fixed on the substrate has an advantage that a large variety of probe molecules can be fixed on a single substrate by, for example, a spotting technique or an ink-jet technique. Utilization of such a biosensor substrate allows comprehensive analysis of a large variety of biomolecules to be conducted rapidly and simultaneously. The representative examples of biosensors utilizing the surface of a substrate are biomolecule sensors, such as DNA microarrays and protein chips.

There are two major methods for manufacturing such biomolecule sensors. One method is an in-situ synthesis of probe biomolecules, such as single-strand DNAs and proteins, by causing nucleotides and amino acids to sequentially react on a substrate and to be fixed thereon by a photolithography technique or an ink-jet technique, and this method is described in U.S. Pat. No. 5,424,186 (Patent Document 1). Another method, which is described in U.S. Pat. No. 5,700,637 (Patent Document 2), involves an ex-situ synthesis of probe biomolecules followed by the fixing of the probe biomolecules thus synthesized on a substrate.

It is expected that biomolecule sensors, represented by DNA microarrays, in the future will be utilized in the field of medical diagnostics, including diagnoses of various diseases, such as cancers. In the case where DNA microarrays are utilized for medical diagnosis, data obtained from the microarray is expected to be highly reliable. In the method of an in-situ synthesis of probe biomolecules on the surface by a photolithography technique or an ink-jet technique, it is impossible to achieve 100% reaction yield in each step of the nucleotide or amino acid incorporation. Therefore, it is difficult to guarantee that the sequence of all the probe molecules provided on a spot is strictly as designed. Furthermore, if nucleotides and amino acids are mistaken in terms of type, or if some parts are lost, due to operation error, it is impossible to examine those mistakes or loss and to eliminate them after manufacturing within the capacity of the current technology. Furthermore, an enormous amount of manufacturing cost will be required for obtaining long nucleic acid sequences and proteins. On the other hand, in the method of an ex-situ synthesis of DNAs and proteins followed by the fixing of the biomolecules on a substrate, the purification process after the synthesis allows the synthesized biomolecules having defective parts and the like to be removed in advance. Hence, it is possible to fix biomolecules for probe having a high purity on the surface, and thereby possible to manufacture a highly-reliable microarray. In this method, biomolecules having a reactive functional group are usually caused to be covalently fixed on the surface. However, upon fixing high molecular weight molecules, such as DNAs and proteins, on the surface of the substrate, there is a problem of nonuniform quantity and structure of the fixed probe biomolecules, resulting in a reduction of data reproducibility (Nature Genetics Vol. 21, pp. 5-9, 1999: Non-patent Document 1). Furthermore, in the process of detecting biomolecules using the microarray, there are problems of non-specific adsorption of biomolecules on the substrate surface and of low sensitivity due to poor control in the density of the fixed probe biomolecules. Such problems eventually make a quantitative sequencing difficult to be conducted (Nature Biotech. 19, p. 342, 2001: Non-patent Document 2).

Meanwhile, aiming at drastically improving precision of gene expression analysis, such as being conducted with the use of DNA microarrays, DNA sequencing methods have been disclosed as in U.S. Pat. No. 6,787,308 (Patent Document 3) and Proc. Natl. Acad. Sci. USA, Vol. 100(7), pp. 3960, 2003 (Non-patent Document 3). The DNA sequencing methods are based on a single-molecule-based sequencing technology, for example, an SBS (Sequencing by Synthesis) method, utilizing a single molecule array of a polynucleotide. In these methods, a complementary strand of a sample polynucleotide is formed on the surface of a substrate by performing a polymerase extension reaction. In this reaction, the sample polynucleotide, which is modified with an appropriate primer and fixed on the surface, serves as a template upon each extension step while nucleotides are added one by one. Different fluorescent dyes are attached to each terminal of purine or pyrimidine bases of the four nucleotides or each terminal of the phosphate groups of triphosphates of the four nucleotides, and the dye-attached nucleotides are identified by performing a single molecule fluorescence detection in each extension step of incorporating a nucleotide. A comprehensive sequence data on the sample can be obtained by repeating this step to determine a sequence for each of the template polynucleotide fixing sites. In this process, it is important to improve the accuracy of sequence determination in DNA sequencing by detection at a high S/N ratio. In this technique, since an enormous amount of fluorescence data from each of the template polynucleotide fixing sites is detected using a CCD camera, an average fixing density of polynucleotide molecules is set according to the pixel size of the CCD camera. In other words, the average density of fixed polynucleotide molecules or the pixel resolution is adjusted such that each pixel manages to receive a fluorescent signal from one polynucleotide. The size of one pixel is at a level of submicron square or larger on the basis of the spatial resolution of the detecting optical system.

In order to efficiently receive a fluorescent signal from each of the polynucleotides with one pixel, the following attempts have been made. Japanese Patent Translation Publication No. 2002-531808 (Patent Document 4) shows a technique to enhance an accuracy of sequence determination in DNA sequencing by fixing a single DNA molecule or a single RNA molecule on a substrate, setting the density of the DNA or RNA molecule at 1 molecule/μm² or less, and further adjusting the fixing density. Japanese Patent Translation Publication No. 2002-521064 (Patent Document 5) introduces a technique for fixing one molecule through a microsphere. It is suggested that, upon maintaining a sufficient intermolecular distance between neighboring molecules, it should be possible to perform DNA sequencing with high accuracy in the cases, for example, where sequencing is conducted for each of the molecules using fluorescence. Regarding a means for aligning colloid microparticles, which are micro/nanospheres, in a grid pattern, a method in which colloid microparticles are plunged into a minute opening pattern formed by a lithography technique to align the microparticles in an orderly pattern is disclosed in Nano Letters, Vol. 4(6), 1093, 2004 (Non-patent Document 4). Furthermore, Japanese Patent Application Laid-Open Publication Nos. 2001-33458 and 2001-235474 (Patent Documents 6 and 7) disclose substrates having a probe molecule group of a single kind aligned in a matrix state. In the meanwhile, in order to reduce noise detected in a sequencing process, it is important to form an adsorption inhibitor which is suitable for a device forming process and has a sufficient adsorption inhibiting ability in a selected region. An example in which adsorption of dNTPs (DATP, dCTP, dGTP and dTTP) is prevented by negatively-charged polyacrylic acid covering the surface of a device is introduced in Non-patent Document 3.

In the second place, when a microarray technique or a sequencing technique, which is a means for DNA sequencing, is used to detect a small amount of sample, it is necessary to increase fluorescence detection sensitivity. A method in which the fluorescence enhancement phenomenon is applied for increasing fluorescence detection sensitivity is reported in Biochem. Biophys. Res. Comm. 306, p. 213 (2003) (Non-patent Document 5). In this method, silver nanoparticles which are modified with probe DNA molecules are fixed to a substrate, and then are caused to react with fluorescently labeled molecules in a sample. Upon irradiating the reaction system with a excitation light for detecting a reaction dose, free electrons of the silver nanoparticles cause resonance vibration (local plasmon resonance), and therefore fluorescence is enhanced. It is suggested that the sensitivity can be improved by utilizing this phenomenon.

The other documents related to the present invention include Jpn. J. Appl. Phys., 41, p. 1579 (2002), and Analytical Biochemistry 298, p. 1 (2001) (Non-patent Documents 6 and 7, respectively).

### SUMMARY OF THE INVENTION

In the methods disclosed in Patent Documents 4 and 5, single DNA molecules to be detected are randomly arranged, and no regularity is observed in the arrangement. Hence, it is difficult to obtain a one-to-one correspondence between one pixel and a spatial arrangement of a DNA molecule serving as a site for emitting fluorescence in a sequencing process. For this reason, it is important to arrange molecules to be detected in order. In the method described in Non-patent Document 4, colloid microparticles are simply physically adsorbed on a surface, and such a state does not provide a sufficient stability of fixing for the microparticles. Therefore, simply following the method cannot provide stable performance of a device even with the colloid microparticles indicating where single DNA molecules are located. In the methods described in Patent Documents 6 and 7, the single DNA molecules are not aligned in an orderly formation. In the method described in Non-patent Document 3, it is highly possible that polyacrylic acid which is physically adsorbed on a surface detaches in the course of various reactions taking place on a device using solutions. Moreover, since other compounds, such as positively-charged polyallylamine, are adsorbed on the surface for the adsorption of polyacrylic acid, it is possible that such compounds provide a site for non-specific adsorption. Meanwhile, in the case where microparticles are utilized for the purpose of orderly aligning single molecules, it is also necessary to provide an adsorption inhibitor for blocking the microparticle surface other than the portion having the probes fixed thereon. In the method described in Non-Patent Document 5, which only focuses on improving fluorescence detection sensitivity, a numerous number of probe molecules are fixed on silver nanoparticles; thus, there is a problem concerning the detection accuracy. In order to improve detection accuracy, it is necessary to devise methods for fixing probe molecules on microparticles.

Although there are ideas for solving problems regarding low accuracy and low reproducibility of biomolecule sensors as described above, each one of the ideas does not provide any effective result. Hence, it is necessary to develop a comprehensive solution based on these ideas and complemented with new ideas.

An object of the present invention is to improve accuracy and reproducibility of biomolecule sensors used in, for example, DNA microarrays and DNA sequencing. The following points are the main causes for decreasing the accuracy and reproducibility.
(1) The density of fixed probe molecules is not quantitatively controlled.
(2) Distances among probe molecules are random, and the biomolecule detection reactions by the individual probe molecules are not independent but interfering with one another.
(3) The residual biomolecules which are non-specifically adsorbed on the surface decrease accuracy of detection signals.

As the cause of (1), the probe molecule fixing reaction involving no measures for controlling the fixing density can be pointed out. The event described in (2) occurs as a result of (1). As the cause of (3), insufficient prevention of non-specific adsorption of biomolecules can be pointed out.

Especially, as the cause of decreasing accuracy and reproducibility in DNA sequencing, it is pointed out that polynucleotide molecules to be detected are randomly fixed on a surface on the basis of a certain average density, that is, there is no regularity in the arrangement of points on which sample polynucleotides are fixed. If neighboring sample nucleotides are too close to each other, fluorescent signals from both polynucleotide molecules are detected in a single pixel; thus, obtained data would be misread. Therefore, such a site is identified as invalid. In addition, for detection of an enormous number of sites emitting fluorescent signals (polynucleotide fixing sites), the fluorescence detection is performed for each area on the surface of the sensor in a step-and-repeat technique. In this process, since all these measuring sites are located randomly, the detection and measurement operations are extremely laborious and time consuming. Accordingly, in sequencing, the random fixation of sample polynucleotides serving as biomolecule to be detected in a biomolecule sensor causes the sample polynucleotide fixing points to be wasted, and incurs restrictions in performance, such as an extended period of time for measurement. Moreover, a single molecule-based sequencing basically requires a single molecule fluorescent measurement; thus, it is necessary to improve fluorescence detection sensitivity for stable fluorescence detection.

A first task to solve the problems described above is to fix individual probe molecules for detecting biomolecules on a substrate surface in a predetermined orderly geometric arrangement such that the individual probes serve as single molecules. A second task is to prevent non-specific adsorption of the sample molecules and other interfering molecules on a region of a substrate surface other than the portion having probe molecules fixed thereon. A third task is to enhance fluorescence detection sensitivity.

It is possible to provide a biomolecule sensor having high sensitivity, high accuracy, and high reproducibility by solving these tasks at the same time.

The present invention provides a biomolecule sensor in which single probe molecules are orderly aligned and fixed respectively on grid points on the surface of a carrier substrate. In order to obtain such a biomolecule sensor, firstly, a grid dot pattern of linker molecules is provided on the surface of the carrier substrate. In this case, the grid form refers to various types, such as square grid, triangle grid, hexagonal grid, honeycomb grid, and rectangular grid. The linker molecules are fixed, at one terminal thereof, on the surface of the carrier substrate, while having a functional group, such as an amino group and a thiol group, which strongly interacts with metals, at the other terminal on the opposite side of the substrate. Next, by causing the functional group and a metal microparticle to bind to each other, one metal microparticle is fixed on each of the linker molecule dots. On each of the metal microparticles, one probe molecule is fixed. Then, on a region of the carrier substrate surface other than the portions having the metal microparticles fixed thereon, that is, the linker molecule dot pattern, adsorption inhibitors are fixed in order to prevent non-specific adsorption of various biomolecules. Furthermore, on a region of the metal microparticle surface other than the portion having the probe molecule bound thereon, second adsorption inhibitors are fixed in order to prevent non-specific adsorption of various biomolecules to the surface of the metal microparticles.

It is preferable that the material of metal microparticle be any of a noble metal, a noble metal alloy, and a noble metal laminate. It is preferable that the diameters of the metal microparticle and the linker molecule dot be approximately comparable.

In addition, by using the noble metal microparticles as a foundation for fixing probe molecules, a near-field effect due to plasmon resonance of the metal microparticles caused by an excitation light for fluorescence detection in the vicinity of the probe molecules can be utilized to enhance fluorescence intensity and to improve fluorescence detection sensitivity. Accordingly, the present invention allows even single-molecule fluorescence to be detected upon sufficient stability.

In the present invention, since the individual probe molecules are fixed apart from one another at determined intervals in an orderly form, each of the probe molecules is put under the same conditions for a reaction with a sample. Furthermore, the reaction between the sample molecule and the probe molecule does not involve interference from the neighboring probe molecules. These contribute to, for example, improvement in reproducibility of detection accuracy in the case where the present invention is adopted in DNA microarrays. Moreover, in the present invention, it is possible to change a fixing pitch of probe molecules if necessary for different purposes, and to recognize the sites where the probe molecules are fixed precisely in advance. Hence, in the case where the present invention is adopted in a single base sequencing process, for example, it is possible to reliably isolate and detect fluorescence signals from individual probe molecule fixing sites and to significantly accelerate the repetitive fluorescence measurement operation on the carrier substrate surface in the step-and-repeat technique by fixing the single probe molecules in an alignment with a pixel pitch of a detection system CCD. Furthermore, since the metal microparticles are used as a fixing foundation of the probe molecules, fluorescence can be enhanced by utilizing the near-field effect on the basis of the resonance between the excitation light for fluorescence detection and free electrons in the metal microparticles; thus, it is possible to stably detect fluorescence even from the single fluorescent molecule.

Accordingly, the present invention can provide a device which, as a biomolecule sensor, can overcome the above-described three tasks regarding detection accuracy, detection data reproducibility, and detection sensitivity, and, at the same time, can significantly speed up the detection steps.

### BRIEF DESCRIPTION OF THE DRAWINGS

FIG. 1 is a drawing showing a basic configuration of the surface of a biomolecule sensor of the present invention.

FIGS. 2A to 2I are drawings showing manufacturing steps of the biomolecule sensor of the present invention.

FIGS. 3A and 3B are image drawings of a DNA hybridization reaction in which the biomolecule sensor of the present invention is used.

FIGS. 4A to 4C are image drawings of a DNA hybridization reaction in which a conventional biomolecule sensor is used.

FIGS. 5A and 5B are drawings explaining fluorescence enhancement in the DNA hybridization reaction in which the biomolecule sensor of the present invention is used.

FIG. 6 is a drawing showing a basic configuration of the surface on which single molecule DNAs to be subjected to a DNA sequencing analysis of the present invention are fixed in a grid array.

FIG. 7 is an image drawing of a DNA sequencing reaction.

FIG. 8 is a drawing showing a DNA sequencing detection system.

FIG. 9 is a drawing showing the relationship between a single metal microparticle arranged in a grid array and a single pixel.

FIG. 10 is an image drawing of a DNA sequencing system utilizing the conventional biomolecule sensor.

FIGS. 11A to 11D are conceptual drawings showing a practical example of manufacturing steps of the biomolecule sensor of the present invention.

FIGS. 12A to 12C are conceptual drawings showing a practical example of manufacturing steps of the biomolecule sensor of the present invention.

FIGS. 13A and 13B are conceptual drawings showing a practical example of manufacturing steps of the biomolecule sensor of the present invention.

FIG. 14 is a drawing showing an electron beam lithography pattern used in the present invention.

FIG. 15 is a drawing showing the detected fluorescence intensity and intensity variation in a gold nanoparticle grid array obtained in the present invention and a conventional array each being hybridized with a complete complementary DNA.

FIG. 16 is a drawing showing the relationship between the detected fluorescence intensity and the concentration of target DNA in the gold nanoparticle grid array and conventional array each being hybridized with the complete complementary target DNA.

FIG. 17 is an image showing an example of gold nanoparticles fixed in a grid form.

FIG. 18 is a drawing showing a sequence for DNA sequencing and a sequencing reaction.

FIG. 19 is a drawing showing a fluorescence detection result of a DNA sequencing process.

### DESCRIPTION OF THE PREFERRED EMBODIMENT

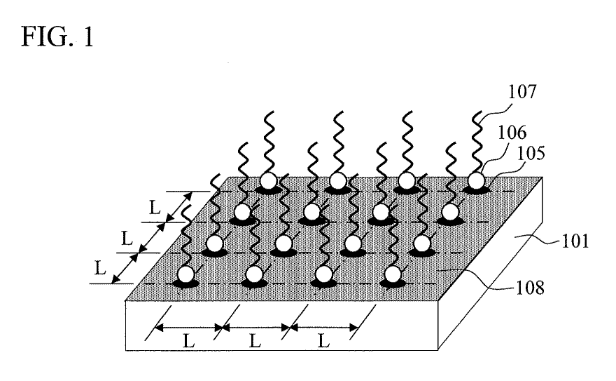

FIG. 1 shows an example of a surface configuration of a biomolecule sensor of the present invention. First, a grid dot pattern of linker molecules is mounted on the surface of a carrier substrate 101. This dot pattern is arranged in a square grid form having a pitch of L along the X- and Y-coordinate axes of the substrate surface. This dot pattern provides metal microparticle fixing dots 105. In this case, the linker molecule refers to a molecule having one end locating on the side of the carrier substrate surface covalently fixed thereon, and having the other end on the opposite side of the substrate with a functional group, such as an amino group and a thiol group, which strongly interact with metals. By causing the functional group to bond with a metal microparticle 106, the single metal microparticle is fixed on each of the metal microparticle fixing dots 105. A single probe molecule 107 is fixed on each of the metal microparticles 106. Then, on a region of the surface of the carrier substrate 101 other than the portion having the metal microparticles 106 fixed thereon, that is, the metal microparticle fixing dot pattern 105, adsorption inhibitors are fixed to form an adsorption inhibitor layer 108 for preventing non-specific adsorption of various biomolecules. Furthermore, on a region of the metal microparticle surface other than the portion having the probe molecule 107 bound thereon, a second adsorption inhibitor is fixed for also preventing non-specific adsorption of various biomolecules to the metal microparticle surface. The adsorption inhibitor layer on the surface of the metal microparticle is not shown in FIG. 1.

With the configuration described above, the present invention provide a biomolecule sensor in which single probe molecules are orderly aligned and fixed on grid points on the surface of a carrier substrate.

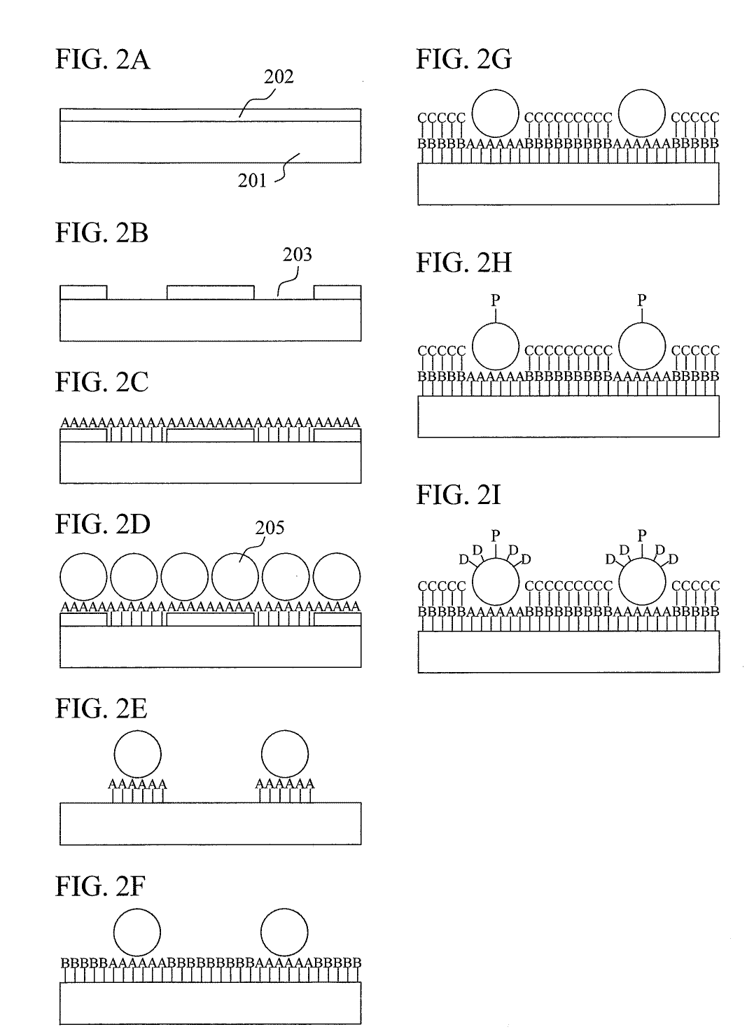

Next, an example of a process concept for manufacturing a biomolecule sensor of the present invention is explained by referring to FIG. 2. In the present embodiment, a process based on a pattern formation by electron beam direct lithography utilizing a positive-type electron beam resist will be described. The manufacturing process consists of the following 9 steps:
(1) coating of positive-type electron beam resist on substrate surface;
(2) formation of openings by electron beam lithography and development;
(3) formation I of linker molecule layer (metal microparticle fixing dot: linker molecule A);
(4) fixation of metal microparticles;
(5) removal of resist;
(6) formation II of linker molecule layer (outer surface on which no microparticle fixing dot is formed: linker molecule B);
(7) formation I of adsorption inhibitor layer (adsorption inhibitor C);
(8) fixation of probe molecules; and
(9) formation II of surface adsorption inhibitor layer (metal microparticle surface: adsorption inhibitor D).

Each step will be described in the following section.

### (1) Coating of Positive-Type Electron Beam Resist on Substrate Surface: FIG. 2A

First, a carrier substrate 201 is washed. To be more specific, after being washed with an alkaline solution, such as NaOH solution, the carrier substrate 201 is washed with an acidic solution, such as HCl solution, rinsed with pure water, and then dried. Alternatively, the carrier substrate 201 is washed with a solution containing sulfuric acid and hydrogen peroxide at a ratio of approximately 4:1 to remove organic contaminants. A glass substrate (slide glass), a quartz substrate, and a plastic substrate, for example, may be used as the substrate in this case. A metal-coated substrate may also be used. It is preferable that the material of substrate contain a silanol group on the surface.

Next, the substrate is spin coated with a positive-type electron beam resist 202, and then dry-baked at a predetermined temperature. In the present invention, it is preferable that the resist film be as thin as possible on condition that it is possible to provide a uniform resist film coating. According to the result of the through process study, it is preferable that the thickness be at most 100 nm or thinner, and more preferable that the thickness be 60 nm or thinner.

The process shown in FIG. 2 describes a case where electron beam lithography is performed on a conductive substrate, such as a Si wafer provided with an oxidized film. In the case where electron beam lithography is performed on a thick oxidized film, such as an oxidized film having a thickness of 10 nm or above, or an insulating substrate, such as a quartz substrate and a glass substrate, an ultrathin film made of a water-soluble electroconductive resin is further formed on the surface of the electron beam resist in order to prevent charging-up of the substrate. This electroconductive resin thin film can also be easily formed by spin coating without causing any influence on electron beam sensitivity of the resist. Moreover, the electroconductive resin thin film can be easily dissolved and removed by washing with water after the lithography process; therefore, the next resist developing step would not be affected at all.

In the present embodiment, the positive-type electron beam resist is used; however, a negative-type resist may be used for different lithography patterning.

### (2) Formation of Openings by Electron Beam Lithography and Development: FIG. 2B

Electron beam lithography is performed by using an electron beam lithography system capable of achieving a target resolution. In this case, using a field emission electron beam lithography system having an effective resolution (minimum processing scale) of 10 nm, a grid dot pattern having a constant pitch in both direction of X and Y coordinates is drawn. The basic pattern is circle, and the main size range is from the minimum of 20 nm φ up to approximately 100 nm φ. The electron beam scanning range is from 75 μm square to 2,400 μm square, and an area of irradiation may be obtained by merging scanning fields if necessary. On the basis of a high precision alignment mechanism using a laser interferometer, accuracy in merging scanning fields of approximately 50 nm or smaller at 3σ (for a scanning field of 600 μm) can be achieved. An electron beam lithography pattern is designed in the form of CAD data, and lithography is performed under computer control. With the lithography pattern provided in a hole drilling process, it is suitable to use a positive-type resist from the viewpoint of throughput. After being provided with the electron beam lithography pattern, the positive-type electron beam resist coated substrate is immersed into a predetermined organic solvent-based developing solution to remove an irradiation part of the resist, and further washed with a rinse agent to obtain an opening pattern 203. Since an opening pattern having a size ranging from 20 nm φ to 100 nm φ cannot be observed under the optical microscope, a pattern resolution test is conducted under an electron microscopy and an atomic force microscope (AFM).

### (3) Formation I of Linker Molecule Layer (Metal Microparticle Fixing Dot): FIG. 2C

The substrate provided with the electron beam resist opening pattern formed thereon is immersed in a solution of linker molecules A to cause the linker molecules A to react with the surface of the oxidized film (SiO₂) on the bottom of the opening pattern. For the linker molecule A, for example, a silane coupling agent having an active group which can be bonded with a metal microparticle may be used. For the silane coupling agent, for example, in the case where an amino group is fixed on the substrate surface, 3-aminopropyltrimethoxysilane, 3-aminopropyltriethoxysilane, N-(2-aminoethyl)-3-aminopropyltrimethoxysilane, (Aminoethyl-aminomethyl)phenethyltrimethoxysilane, and the like, can be used. In the case where a thiol group is fixed on the substrate surface, 3-mercaptopropyltrimethoxysilane can be used. For the solvent, for example, methanol, ethanol, toluene, benzene, and water can be used. The reaction temperature is generally in a range from 20° C. to 80° C. In this process, while being covalently fixed to the silanol group on the surface of the oxide film in the opening bottom, the linker molecules A are simply physically adsorbed on the surface of the resist in which no binding group exists thereon. Being exposed on the opposite side of the substrate, the amino group or thiol group of linker molecule A is to be bonded with a metal microparticle in the next step.

In the present embodiment, the linker molecule layer is formed in the step (3) after the electron beam resist opening pattern is formed in the steps (1) and (2). However, it is also possible that the linker molecule is bonded to the whole surface of the substrate in the step (3) after washing the substrate, and then the electron beam resist opening pattern is formed in the steps (1) and (2).

### (4) Fixation of Metal Microparticles: FIG. 2D

Metal microparticles are fixed on the surface of the substrate through an interaction between the active group on the substrate surface and the metal microparticle. FIG. 2D shows the carrier surface having metal microparticles 205 fixed thereon. For the metal microparticle material, any of noble metals including gold, silver, platinum, palladium, rhodium, iridium, ruthenium, and osmium, or any of alloys of these noble metals can be adopted. Alternatively, a microparticle made of any of these noble metals provided with other noble metal coated thereon, such as a gold microparticle provided with silver coated thereon, may be adopted. The size of metal microparticle which can be used in this case is 0.6 nm or larger, which is the size providing stability to a metal microparticle. From the viewpoint of stability in the fixing of the metal microparticle to the substrate, it is preferable that the metal microparticle size be 10 nm or larger. From the viewpoint of fluorescence enhancement, it is preferable that the metal microparticle size range from 10 nm to 1 μm inclusive, which is the size providing the fluorescence enhancement effect. From the viewpoint of effective fixing of single biomolecules on the surface of the metal microparticle in the next step, it is preferable that the metal microparticle size be 100 nm or smaller. Hence, on the basis of these three viewpoints, it is preferable that the metal microparticle size range from 0.6 nm to 1 μm inclusive, and more preferably range from 10 nm to 100 nm inclusive for the fixation.

For a solvent in the fixing reaction of the metal microparticles, water, ethanol, or toluene can be used. A protective reagent is used for prevention of aggregation of the metal microparticles in the solution. For the protective reagent, for example, citric acid, mercaptosuccinic acid, polyvinylpyrrolidone, polyacrylic acid, tetramethyl ammonium, polyethylenimine, 1-decanethiol, 1-octanethiol, decylamine, and phosphine (bis(p-sulfonatophenyl)phenylphosphine) can be used.

The concentration of metal microparticle is generally 30 wt % or less, and the reaction temperature is generally in a range from 20° C. to 85° C. The reaction time is in a range from 0.5 hours to 50 hours. The density of fixed metal microparticles can be controlled upon changing these reaction conditions. For example, the fixing reaction of the metal microparticles, which is the first-order reaction for the concentration of metal microparticles in the fixing solution, is a Langmuir-type reaction. Therefore, by changing the concentration of metal microparticles in the fixing solution and/or the reaction time, it is possible to obtain a desired fixing density. The reaction time of metal microparticles is determined according to the reaction time thereof on a simple surface having only linker molecules and no resist pattern. In this step, the purpose is simply to cause the metal microparticles 205 to reach the bottom of the resist opening portion 203, and to cause the surface active group and the metal microparticle to react with each other for fixing the metal microparticles.

In this case, it is desirable that only single metal microparticle goes into each of the sites and be fixed thereon, and that the relationship between the metal microparticle size and the size of the electron beam resist opening portion satisfy the following condition in order to maintain the high enough filling rate of the metal microparticles fixed on the dot pattern: 0.5≦γ≦1, where γ denotes the ratio of the metal microparticle diameter and the electron beam resist opening portion diameter. When γ is smaller than 0.5, multiple metal microparticles end up going into each site because the metal microparticle size is sufficiently smaller than the electron beam resist opening size. On the other hand, when γ is larger than 1, the filling rate is significantly lowered because the metal microparticles cannot diffuse on the bottom of the electron beam resist opening portion.

### (5) Removal of Resist: FIG. 2E

The substrate completed going through the step (4) is immersed into a resist removal solution to dissolve and remove the resist. In this process, the excess metal microparticles and linker molecules A adsorbed on the resist are removed as well by liftoff, and only the microparticle fixing dots consisting of surface reactive molecules A covalently bound to the substrate surface and the metal microparticles fixed thereon remain. The important points in this step are that only single metal microparticle is fixed on each dot pattern site, that the filling rate of the metal microparticles fixed to the dot pattern is high, and that no residual metal microparticle attaches to a region other than the dot regions.

In the present embodiment, the resist is removed in the step (5) after the metal microparticles are fixed in the step (4). However, the metal microparticles may be fixed in the step (4) after resist removal in the step (5). To be more specific, the resist may be removed first, and then the metal microparticles are fixed by causing the surface having only the linker molecule layer aligned in a form of dots and the metal microparticle solution to react with each other. Furthermore, the linker molecules are bonded in the step (3) first, and then the metal microparticles are fixed in the step (4) in the present embodiment. However, the linker molecules may be bonded in the step (3) after the metal microparticles are embedded into the resist opening pattern by capillary force and the like in the step (4).

### (6) Formation II of Linker Molecule Layer (Outer Surface on Which No Microparticle Fixing Dot is Formed: Linker Molecule B): FIG. 2F

It is highly possible that biomolecules and chemical agents, such as dNTPs, to be used in the following steps are non-specifically adsorbed to the surface in which no metal microparticles are fixed on the substrate surface. Since such non-specific adsorption causes noise when the sensor is used as a device, it is necessary to be completely prevented. Hence, adsorption inhibitors are fixed on the region other than the metal microparticle fixing dot pattern for preventing the non-specific adsorption. FIG. 2F shows linker molecules B formed for this purpose. If a silane coupling agent containing an amino group or a thiol group, which is the same silane agent used to form the metal microparticle fixing dots, is used in this process, the final process of fixing probes on the metal microparticle surface might be interfered because the agent can also react with the surface of the metal microparticles having been fixed on the substrate surface. Therefore, it is preferable to use a linker molecule which does not interact with the metal microparticles but reacts only with the substrate surface. For a compound providing such a linker molecule, silane coupling agents having, for example, an epoxy group and a carboxyl group, are promising.

### (7) Formation I of Adsorption Inhibitor Layer (Adsorption Inhibitor C): FIG. 2G

Adsorption inhibitors C for prevention non-specific adsorption of biomolecules are bonded on the linker molecules B formed in the step (6). In the case where the linker molecule B is the silane coupling agent having an epoxy group as mentioned above, it is effective to use adsorption inhibitors having an amino group, a hydroxyl group, and the like, which react with the epoxy group and carboxyl group. For example, low-molecular-weight polyethylene glycol (PEG) having an amino group at the end and carboxymethyl dextran (CM-Dextran) having a hydroxyl group can be used in the place of the adsorption inhibitor C. Incidentally, the adsorption inhibitors C are not necessarily required if the non-specific adsorption can be sufficiently prevented only by the linker molecules B.

On the substrate prepared in the previous steps, the single metal microparticle is fixed on the microparticle fixing dots in a grid pattern formed by the electron beam lithography with high accuracy, and the adsorption inhibitors for preventing the non-specific adsorption are coated on the region other than the regions of microparticle fixing dots. The substrate prepared in the previous steps up to this point is referred to as a metal microparticle grid array substrate.

### (8) Fixation of Single Probe Molecule: FIG. 2H

The purpose of this step is to fix only one probe molecule on each of the metal microparticles by causing the metal microparticle fixed on the metal microparticle grid array substrate to react with a probe molecule having a functional group capable of being bonded to the metal microparticles. FIG. 2H shows the substrate surface having the probe molecules denoted as P.

In the following section, a case where a gold nanoparticle is used in the place of the metal microparticle, and where a probe DNA having a thiol group at the 5′ terminal is used in the place of the probe molecule will be described. When a substrate which is provided with the gold nanoparticles fixed thereon upon dispersing evenly and randomly, and then which is coated with the adsorption inhibitors for preventing the non-specific adsorption described in the steps (6) and (7) is caused to react with terminally thiolated DNA, the thiol group only reacts with the gold nanoparticle surface and adsorbs thereon. The level of adsorption was quantified using an SPR (surface plasmon resonance) method which is capable of measuring an adsorption reaction. In the range of the measuring sensitivity of the SPR method, it is difficult to measure the amount of adsorption when only one probe molecule is adsorbed to each of the gold nanoparticles. For this reason, the relationship between the concentration of a DNA solution and the number of fixed probe molecules was evaluated upon causing more than one probe molecules to be fixed to each of the gold nanoparticles. It was found that the relationship was shown by a simple Langmuir-type adsorption curve. On the basis of this curve, it is possible to estimate the concentration of the probe molecule solution when only one probe molecule is adsorbed to each of the gold nanoparticles. A probe DNA solution having an optimum concentration of probe molecule estimated from this adsorption evaluation experiment is prepared. A gold microparticle grid array substrate in which same-sized gold microparticles are fixed on orderly aligned grid dots is immersed into the probe DNA solution having the optimum concentration of the probe molecule estimated on the basis of the adsorption level evaluation experiment, caused to react at a predetermined temperature for a predetermined period of time, then washed with a washing solution, and dried.

The number of probe DNA molecules fixed on each of the gold nanoparticles on the substrate was measured. A single molecule fluorescence measurement was performed on an optical microscope stage upon using a combination of a highly sensitive image intensifier and a CCD camera according to the method disclosed in Non-patent Document 6. By using this method, it is possible to detect fluorescence from individual fluorescent dye molecules (single molecule fluorescence) fixed within the observation field on the sample substrate surface as an image in real time. A mere probe DNA has no fluorescence, and thus the fluorescence is not detected. In order to verify the fixing of single probe DNA molecules, fluorescence measurement was performed upon hybridizing terminally thiolated DNA fixed on the gold nanoparticle with completely complementary DNA labeled with a fluorescent dye. For verification of single molecule fluorescence, probe DNA having a thiol group at the one terminal and having a fluorescent molecule, such as Cy3, Cy5, and Rhodamine B, at the other terminal may also be used for the experiment. In all the cases, repetitively blinking fluorescence and fluorescence photobleaching in a staircase pattern, which are the characteristics of single molecule fluorescence, were observed. The fluorescence photobleaching in a staircase pattern is a phenomenon observed while fluorescence intensity is continuously monitored for fluorescence detection. In the phenomenon, fluorescent dye molecules are oxidatively decomposed one after another, resulting in a staircase reduction of fluorescence intensity each time a fluorescent dye molecule is decomposed. In the case of observing fluorescence of a single fluorescent dye molecule, the fluorescence photobleaching can be confirmed by fluorescence disappearing at once as the molecule is decomposed. By using the measuring method described above, optimum process conditions (concentration of the probe DNA solution, reaction temperature, and reaction time) for fixing the single probe DNA molecules on the gold nanoparticles on the surface of the gold nanoparticle grid array were determined.

An aqueous solution having a near-neutral pH, such as a phosphate buffer, can be used for a solution to dissolve the probe DNAs. The probe DNAs are dissolved in the solution. Regarding the concentration of the probe DNAs in this process, although it is generally in a range from 0.5 μm to 100 μm for a conventional DNA chip, for example, it is most preferable to be a few nM or below in the case where the single probe DNA is fixed on each of the gold nanoparticles on the gold nanoparticle grid array substrate as in the present invention. Incidentally, the optimum concentration of probe DNAs depends on the state of the fixing surface, and, to be more specific, varies according to the size and fixing density (grid array pitch) of the gold microparticles. Hence, the optimal concentration of probe DNAs was determined for each case according to a gold microparticle grid array design. The reaction time was set to be longer than the time required for the reaction to sufficiently achieve the equilibrium.

In the case of a gold nanoparticle grid array substrate using a Si wafer or a glass substrate as a carrier, a reaction solution including probe DNA dissolved therein can be spotted, in a desired size, on a desired position of the substrate. In this process, it is possible to spot various kinds of probe DNAs on the substrate, and such a substrate having various probe DNAs spotted thereon can be used as DNA microarrays, for example. The reaction temperature is generally in a range from 25° C. to 40° C. The reaction time is generally in a range from 2 hours to 24 hours. The reaction is conducted in an environment in which sufficient humidity is maintained to prevent the solution from being dried up during the reaction.

Since gold and a thiol group are prone to be bonded to each other, the terminally thiolated probe DNA is fixed only on the gold nanoparticle. The region on which no gold nanoparticle is fixed (the region other than the regions of the gold microparticle fixing dots) is covered with the adsorption inhibitors C; thus, almost no probe DNA adsorbs thereon. Coating with adsorption inhibitors is hereinafter referred to as blocking.

In the present embodiment, after the metal microparticles are fixed on the substrate, the substrate surface other than the portions thereof having the metal microparticles fixed thereon is subjected to blocking, and then the probe molecules are fixed. However, the substrate surface other than the portions thereof having the metal microparticles fixed thereon may be subjected to blocking, after the probe molecules are fixed on the metal microparticles and then the metal microparticles are fixed on the surface.

### (9) Formation II of Surface Adsorption Inhibitor Layer (Metal Microparticle Surface): FIG. 2I

It is possible that sample biomolecules are adsorbed on the region of the metal microparticle surface having no probe DNAs fixed thereon. Therefore, the metal microparticle surface other than the portion thereof having the probe DNA fixed thereon was subjected to blocking. FIG. 2I shows the substrate surface after the metal microparticle surface was subjected to blocking with adsorption inhibitors D.

In the present embodiment, a case where gold nanoparticles are used as the metal microparticles is described. For a blocking reagent which is prone to react with gold and difficult to adsorb biomolecules, 1-mercaptohexanol and 2-mercaptoethanol may be used, for example. A blocking reagent is fixed on the gold nanoparticles by causing a solution containing the blocking reagent dissolved therein to react with the carrier surface.

The reaction temperature is generally in a range from 4° C. to 35° C., and the reaction time is generally in a range from 0.5 hours to 10 hours. In this reaction, when the concentration of the blocking reagent in the solution is high, the bonding force between the metal microparticle and the carrier is weakened by the blocking reagent reacting with the gold nanoparticle and thereby coating the gold nanoparticle. As a result, the gold nanoparticles diffuse on the carrier surface, and then aggregate thereon. Accordingly, the concentration of the blocking reagent reaction solution is set to be 100 μm or below.

In the present embodiment, the adsorption inhibitors D are fixed after the probe DNAs are fixed on the metal microparticles. However, the probe DNAs and the adsorption inhibitors D may be fixed at the same time. In other words, after mixing the adsorption inhibitors D into a solution having the probe DNAs dissolved therein, the solution and the metal microparticles may be caused to react with each other.

A case where a gold nanoparticle grid array substrate having probe DNAs, in the place of probe molecules, fixed on the gold nanoparticles is used as a DNA microarray will be described in the following sections (10) and (11).

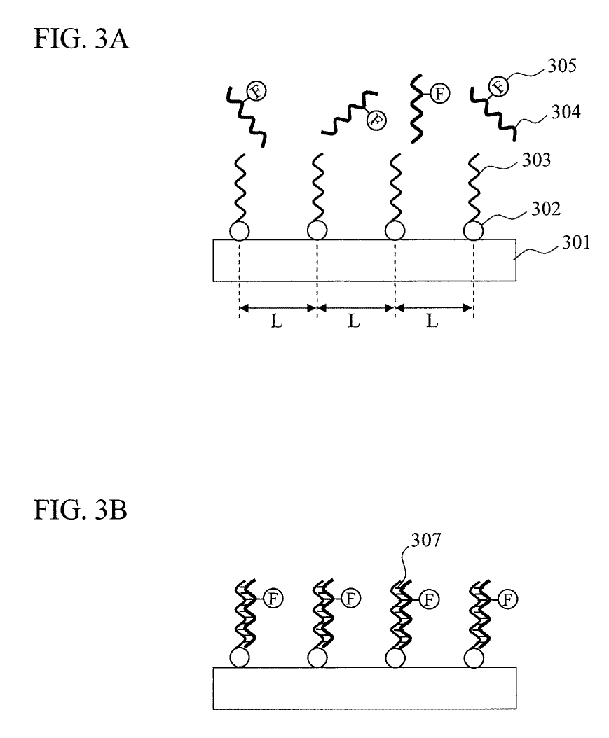

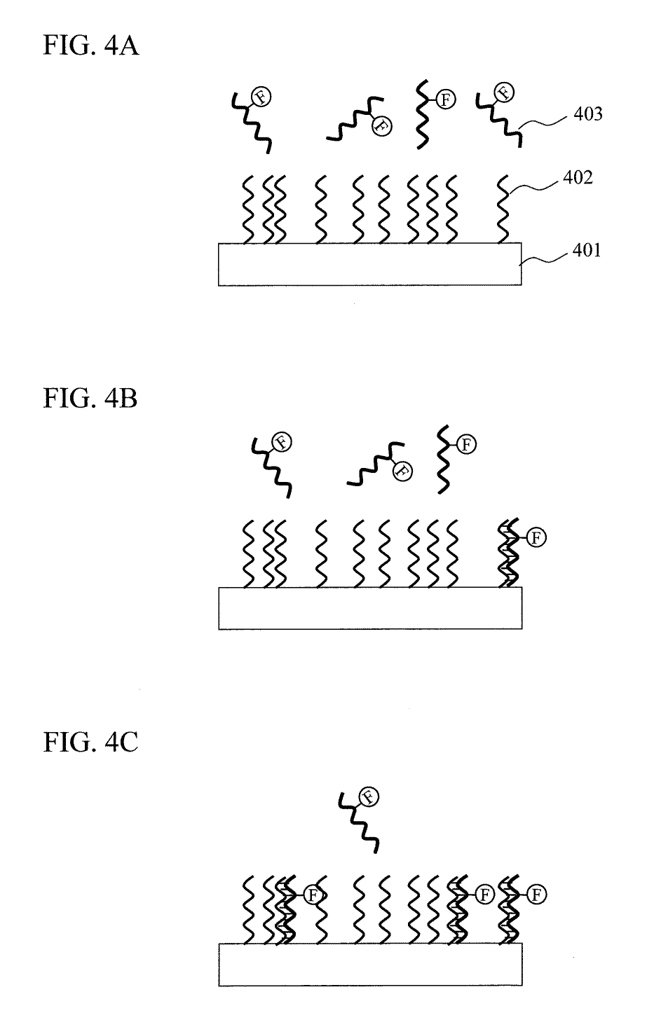

### (10) Evaluation Step for DNA Microarray Hybridization Reaction: FIGS. 3 and 4

The surface of the biomolecule sensor having the metal microparticle grid array substrate prepared in the previous steps (1) to (9) was caused to react with a fluorescently labeled sample solution. Here, a case where a probe DNA and a nucleic acid are used in the place of a probe molecule and a biomolecule to be detected, respectively, will be explained by referring to FIG. 3. For simplification, the linker molecules and the adsorption inhibitors are not shown in the drawings. A substrate 301 is provided with metal microparticles 302 aligned at an equal pitch L and fixed thereon, and then the metal microparticle 302 is provided with a probe DNA 303 fixed thereon. FIG. 3A shows the situation in which the substrate 301 is supplied with a fluorescently labeled target DNA 304 with a fluorescent molecule 305 as a sample to be analyzed. When the probe DNA and the target DNA have completely complementary nucleic acid sequences, the reaction proceeds rapidly to produce a double stand DNA formed through complementary hydrogen bonds 307, as shown in FIG. 3B. This process is called a hybridization reaction. The important point in this process is that there is no mutual interference among the individual probe DNAs, since they are precisely isolated and fixed at certain intervals under uniform environmental conditions. Hence, it is unlikely that variation in the reaction time and reaction efficiency occurs with the biomolecule sensor based on this substrate.

On the other hand, on the surface of a conventional biomolecule sensor as shown in FIG. 4, the fixing density of probe DNAs 402 is random as shown in FIG. 4A, and there are both dense and nondense parts of the fixed probes on the surface of a substrate 401. Therefore, even in the hybridization reaction performed in the same manner as described above, there are some probe DNAs 402 immediately reacting with target DNAs 403 and others taking longer time to react therewith. Hence, variation in progress of hybridization reaction as shown in FIGS. 4B and 4C tends to occur.

For these reasons as described above, the biomolecule sensor of the present invention allows the target surface reaction to progress uniformly and efficiently, resulting in significant improvement in accuracy and reproducibility of detected data.

Incidentally, the specific conditions of the hybridization reaction are as follows. Fluorescently labeled nucleotides for detection are dissolved in a SSC (Standard Saline Citrate) solution added with a surfactant, and the solution thus obtained is caused to come in contact with the surface of the biomolecule sensor. The amount of nucleic acid in the solution ranges from 0.1 amol to 1 mmol. The reaction temperature is generally in a range from 25° C. to 60° C., and the reaction time is generally in a range from 1 hour to 24 hours. Under these conditions, having the completely complementary sequences, the nucleic acids to be detected and the probe DNAs rapidly react with each other to produce double-strand DNAs formed by the complementary hydrogen bonds. For DNA microarrays, probe DNAs having various sequences are caused to hybridize with a sample to be analyzed in multiple spots on the substrate surface, and the intensities of fluorescence from the individual spots are measured using a fluorescence scanner and obtained as data.

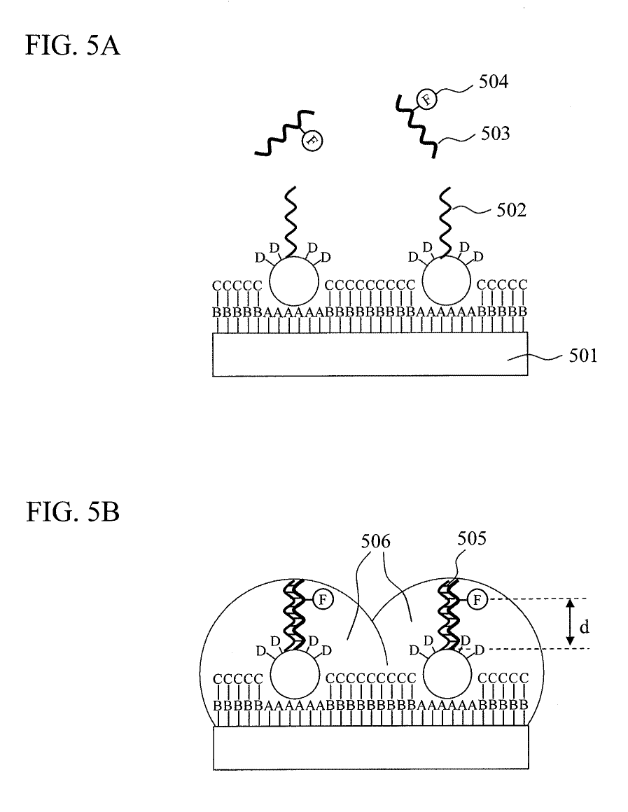

### (11) Fluorescence Enhancement: FIG. 5

By using the metal microparticle in the fixing site for the probe molecule, the present invention can utilize a fluorescence enhancement phenomenon, which is another feature of the present invention. The expression of the fluorescence enhancement phenomenon in the present invention will be explained by referring to FIG. 5. FIG. 5 shows the sensor prepared according to the manufacturing method of a biomolecule sensor of the present invention described in FIG. 2. In the sensor, the probe molecule denoted as P in FIG. 2H is replaced with DNA. FIG. 5A shows the state of the sensor before the hybridization between a probe DNA 502 fixed on a metal microparticle on a substrate 501 and a target DNA 503 fluorescently labeled with a fluorescent molecule 504, and FIG. 5B shows the state after the hybridization. The drawings show the hybridization taking place between completely complementary strand DNAs.

Fluorescence intensity is enhanced due to local plasmon resonance which is unique to metal microparticles. First, local plasmon resonance and fluorescence enhancement will be explained. Detailed description for this phenomenon is provided in Non-patent Document 7. When light comes into a metal microparticle, free electrons in the metal microparticle are caused to polarize and vibrate. Resonance between the vibration of the free electrons in the metal microparticle and the oscillating electric field of the incident light is referred to as local plasmon resonance. When the local plasmon resonance occurs, the electric field intensity on the surface of the metal microparticle becomes larger by several orders of magnitude than the electric field intensity of the incident light. Next, two factors involved in the above-described fluorescence enhancement will be explained. One factor for fluorescence enhancement is improvement in the quantum yield of fluorescent molecule. When a metal microparticle exists in the vicinity of a fluorescent molecule, absorption transition (electronic transition) occurs due to the electric field enhancement effect in the vicinity of the metal microparticle caused by local plasmon resonance in the process of photoenergy absorption of the fluorescent molecule. In addition, the presence of the metal microparticle in an emission process accelerates the rate of the photoemission process. Hence, due to the occurrence of absorption transition and the increase in emission rate, the quantum yield of the fluorescent molecule is increased. Note that, since the quantum yield never goes beyond 1, the increase in quantum yield by providing metal microparticles cannot be expected in the fluorescent molecule having a quantum yield of 1. However, since a majority of fluorescent molecules which have been practically used in biosensors have a quantum yield ranging approximately from 0.04 to 0.3, improvement in the quantum yield by providing metal microparticles can be expected in these fluorescent molecules.

The other factor is an increase in light scattering intensity by providing metal microparticles. When the polarizability of metal microparticles is increased by the local plasmon resonance and therefore the adjacent electric field thereof is enhanced, the intensity of scattering light from the metal microparticles is also enhanced. This is because the scattering light intensity is proportional to the square of the polarizability of the metal microparticles. As the scattering light intensity increases, the incident energy density for excitation of fluorescent molecules is increased, and, as a result, the fluorescence emission intensity is also increased.

Such a fluorescence enhancement effect is observed in the distance between the metal microparticle and the fluorescent molecule ranging from approximately 5 nm to approximately 100 nm. The region where the fluorescence enhancement effect is observed is shown as a near-field 506 in FIG. 5B. When a distance d along the probe molecule between the end thereof fixed on the metal microparticle and the fluorescent molecule modified on the target molecule is within a range from 5 nm to 100 nm, where the fluorescence enhancement effect is obtained, the fluorescence enhancement effect can be obtained after the probe molecule reacts with the target molecule to form complementary hydrogen bonds 505.

Due to the above-described mechanisms, the metal microparticle used for the fixing site for the probe molecule allows ultrasensitive detection of a fluorescently labeled target molecule; thus, it is possible to achieve significant improvement in sensitivity of the biomolecule sensor.

Next, a case where the metal microparticle grid array substrate prepared in the steps (1) to (9) described above is used for DNA sequencing will be explained.

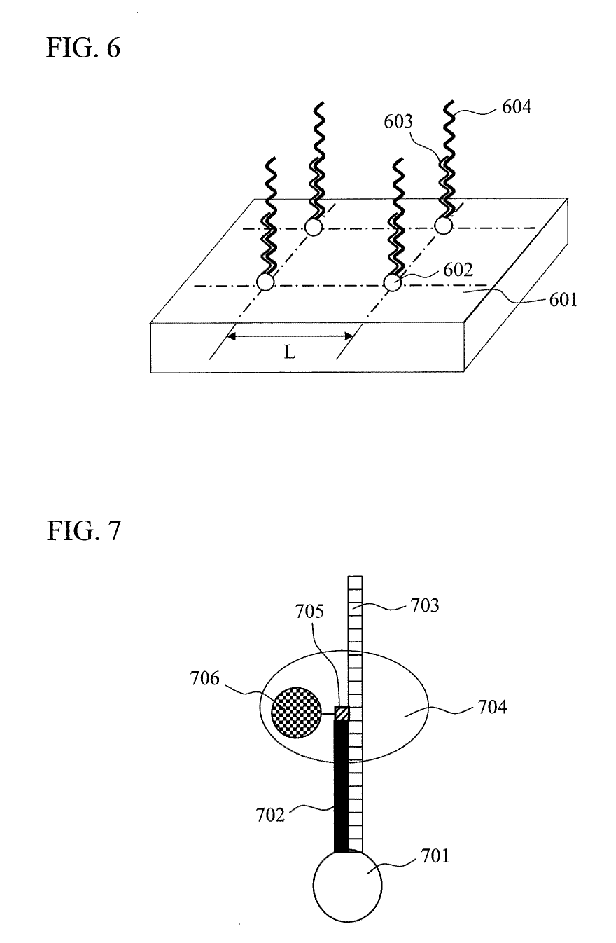

### (12) Fixation of Target Molecule for DNA Sequencing Analysis: FIG. 6

First, probe molecules 603 for fixing single strand DNA 604 to be subjected to sequencing are aligned on a substrate 601 through metal microparticles 602 by following the previous steps (1) to (9). Next, the single strand DNA 604 to be sequenced is caused to react with each of the probe molecules 603, and fixed on the substrate 601. The conditions of the reaction between one single molecule DNA to be sequenced and one probe molecule are as follows. The single strand DNAs are dissolved in a solution containing salt, such as NaCl, and the solution thus obtained is caused to come in contact with the surface of an array substrate on which the probe molecules are fixed. The reaction temperature is generally in a range from 20° C. to 80° C., and the reaction time is generally in a range approximately from 1 hour to 24 hours. For the probe molecule to react with the single strand DNA to be sequenced, it is necessary that the probe molecule have a reaction site for fixing the single molecule DNA. For example, when a single strand DNA to be sequenced has a poly A sequence, such as AAAAAAAAA, a probe molecule to be used has a poly T sequence with successive Ts, such as TTTTTTTT, which is complementary to the poly A sequence.

Next, the size of pitch L of the gold nanoparticle 602 grid array shown in FIG. 6 will be explained. As described in Description of the Related Art, a DNA sequence is determined by measuring fluorescence intensities in DNA sequencing. In the sequencing process, it is required to measure fluorescent signals from a fixed single molecule DNA and other neighboring single molecule DNAs separately. Therefore, it is necessary to set the pitch L to be equivalent to or larger than the resolution of a fluorescence reading optical system. For the same reason, it is also necessary to set the pitch L to be larger than the pixel size of a CCD camera reading.

### (13) Sequencing: FIG. 7

As shown in FIG. 7, a nucleotide 705 is added to the top end of a probe molecule 702 by polymerase 704 in a polymerase reaction using the probe molecule 702 as a primer for single base extension. In this reaction, nucleotides are, for example, prepared by being dissolved in a solution containing salt, such as magnesium chloride, and the solution thus obtained is caused to come in contact with a substrate. Agents, such as dithiothreitol (DTT), glycerol, and surfactant, which are capable of preventing inactivation of the polymerase enzyme may be added to the solution by mixing. As shown in FIG. 7, the added nucleotide 705 is modified with a fluorescent molecule 706. By reading a fluorescent signal from this fluorescent molecule, it is determined whether or not a nucleotide has been incorporated. And then the type of the incorporated nucleotide, such as A, T, C, and G, is identified.

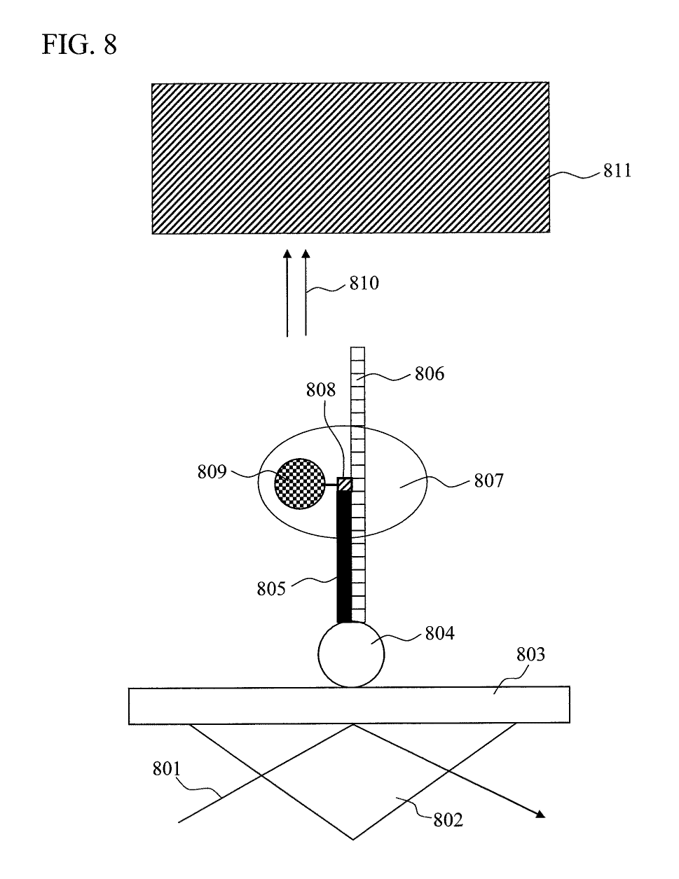

FIG. 8 shows a sequencing detection system. In this system, an excitation laser beam 801 enters from the back surface of a substrate 803 through a quartz prism 802 under total internal reflection conditions. In the process of single base extension, a fluorescent molecule 809 bound to an introduced nucleotide 808 is excited by an evanescent light, which is a part of the total internal reflection incident laser beam, leaking to the side on which a single molecule DNA 806 is fixed thereon. Fluorescence 810 generated is measured by a highly sensitive camera 811 mounted above the upper surface of the substrate. After the nucleotide 808 is bonded, for example, the phosphate group of the nucleotide 808 incorporated by the action of polymerase 807 is detached. When the fluorescent molecule 809 is bound to the nucleotide 808 at the terminal of the phosphate group thereof, the fluorescent molecule 809 is detached and removed from the single molecule DNA 806 to be sequenced while the phosphate group is detached. After the removal, a different kind of nucleotide is caused to react. For example, firstly, a solution containing a nucleotide A and a substrate are caused to come in contact to each other. Then, if the nucleotide A is incorporated in the process of single base extension by the polymerase reaction, fluorescence is detected by the detection system. If no nucleotide A is incorporated in the process of single base extension, no fluorescence is detected. In a grid site where fluorescence has been detected, it proves that the single molecule DNA to be sequenced has a nucleotide T which is complementary to A, at the position to be sequenced. On the other hand, in a grid site where no fluorescence is detected, it proves that the single molecule DNA does not have a nucleotide T at a position to be sequenced. Next, after a solution containing a nucleotide C, for example, and the substrate are caused to come in contact to each other, fluorescence detection is performed. In this process, it is determined whether or not a single molecule DNA in each grid site has G, which is complementary to C, at the position to be sequenced. Subsequently, nucleotides T and G are sequentially caused to react in the same manner. Upon repeating this operation, the sequence of a single molecule DNA fixed on each grid site is determined.

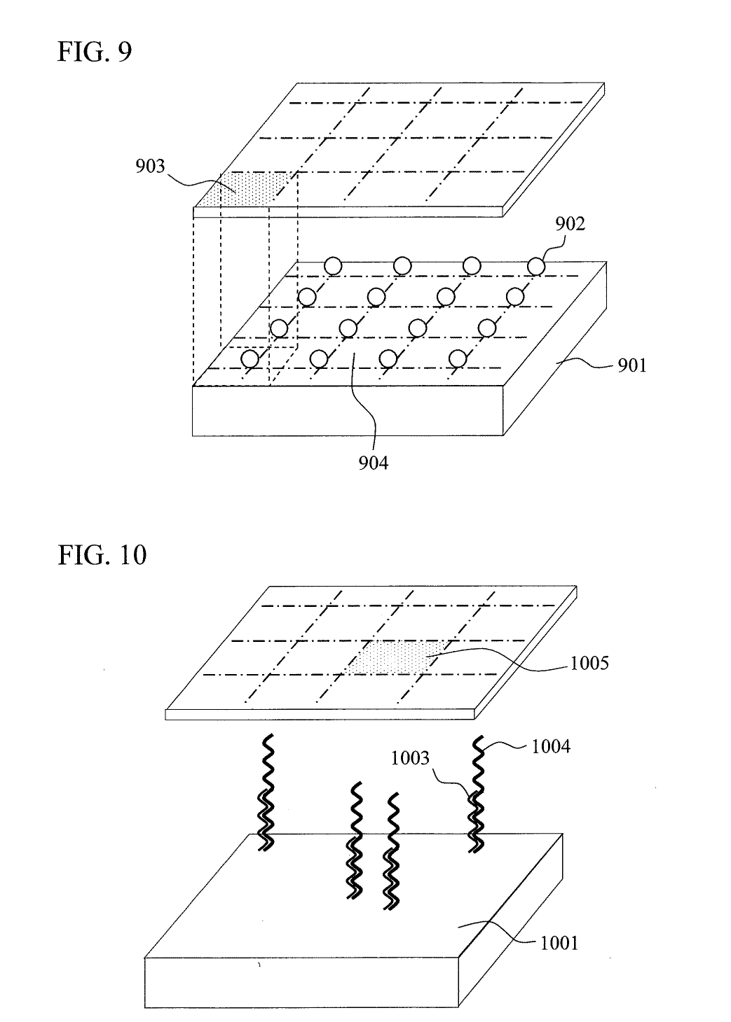

The important point in this process is that there is no mutual interference between a detected fluorescent signal and a signal emitted from the neighboring single molecule DNA, since the single molecule DNAs 806 in the present invention are isolated from one another and fixed at certain intervals. Therefore, for example, when the size of one pixel 903 of a CCD camera for detecting fluorescence and the size of a gold nanoparticle grid 904 are the same as shown in FIG. 9, it is possible to measure a fluorescence intensity of each grid site independently. In other words, it is possible to determine a DNA sequence at each grid site independently. Accordingly, the DNA sequence can be determined with high accuracy. A fluorescence signal from one grid site may be detected with, for example, 4 pixels or 9 pixels, upon increasing the number of pixels. Furthermore, the fluorescence intensity is enhanced due to the effect of metal microparticles 902 serving as a fixing site of DNA. The underlying mechanism has been previously described in the step (11). For highly sensitive measurement of a single molecule fluorescence signal, there are generally several requirements, such as to increase a power density of the excitation light and to use a device capable of amplifying photons in the detection system; thus, fluorescence excitation and detection system together become a large-scale and complicated system. However, it is possible to design a compact fluorescence detection system by utilizing the fluorescence enhancement effect of the present invention.

On the other hand, in the case where single molecule DNAs 1004 to be sequenced are randomly fixed on a substrate 1001 as shown in FIG. 10, the distance among single molecule DNAs cannot be controlled. Therefore, one pixel 1005 may end up measuring fluorescent signals from two or more single molecule DNAs in some cases. In such a case, it is difficult to separate signals from two DNAs, and, as a result, some signals may be misread and/or some DNAs may not be sequenced. Furthermore, when the single molecule DNAs 1004 are randomly fixed, their positions are unknown at the initiation of sequencing; thus, it is necessary to confirm the positions prior to the initiation of sequencing. For example, it becomes necessary to carry out an additional process, such as fluorescence mapping, in which the positions of the fixed single molecule DNAs are specified and the system is caused to memorize the positions, after fixing the single molecule DNAs having fluorescent molecules bound thereto. Furthermore, since the effect of fluorescence enhancement by metal microparticle cannot be used, the fluorescence detection system becomes large scale and complicated.

By using the metal microparticle grid array substrate of the present invention, the accuracy of sequencing can be significantly improved, and all DNA sequences can be determined without having any invalid DNAs which cannot be sequenced. Furthermore, since the positions (coordinates) of fixed DNAs to be sequenced are known in advance, the process of specifying the positions can be omitted.

In the present invention, an orderly dot pattern consisting of linker molecules is formed on the carrier substrate surface by the lithography process, and firstly a metal microparticle grid array is formed utilizing the bond between the active group of the linker molecule and the metal microparticle. The lithography technique is not limited to electron beam (EB) lithography, and near-field lithography may be adopted as an alternative to the EB lithography. In the case of adopting the near-field lithography, a membrane mask is prepared by the EB lithography, and a resist process is performed by contact photolithography using this mask. In this case, resists having the same pattern can be prepared repeatedly in high-throughput; thus, a highly mass productive process can be achieved. In addition, without using lithography, an orderly dot pattern of linker molecules can be formed by a nano-contact printing technology or a nano imprint technology.

In the next section, the present invention will be further described in detail by referring to examples, especially the examples in which the present invention is used in DNA microarrays and DNA sequencer. It should be noted that the present invention is not limited to the following examples, and is a basic technique contributing to improvement in characteristics of any kinds of biomolecule sensors aiming at nucleic acids, proteins, and carbohydrate chains and so on.

### Example 1

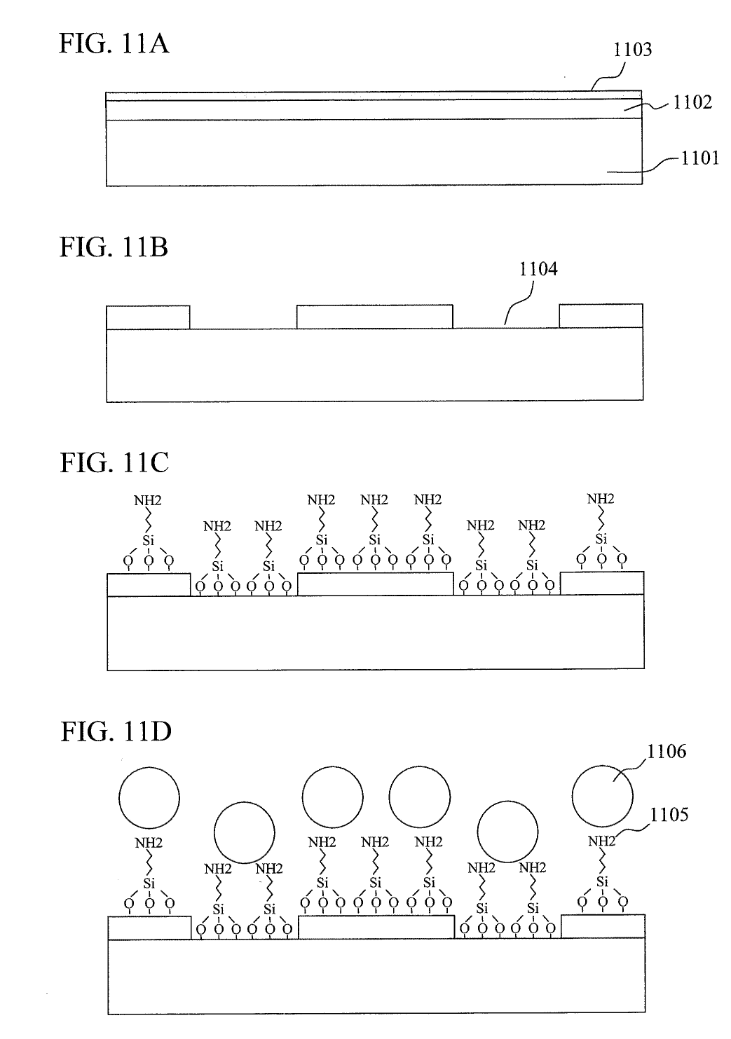

### (Step 1) Coating Step of Positive-Type EB Resist on Substrate Surface: FIG. 11A

A Si substrate having a diameter of 4 inches (about 102 mm) provided with a highly flat thermally-oxidized film of 100 nm was used in the place of a carrier substrate 1101. The substrate was washed with a 0.1 wt % NaOH solution, further washed with a 0.1 wt % HCl solution, rinsed with pure water, and then dried. A main chain scission-type positive-type resist was used as the resist in this example. After being diluted with anisole, the resist was coated on the substrate using a spin coater. After coating, the substrate was baked at 180° C. in an N₂ flow for 20 minutes for removal of the solvent. In this example, a resist film thickness of 60 nm, which is sufficiently thin and is not worn out by the EB processing, was adopted (resist:anisole=1:3 dilution). In order to prevent charging of the substrate during the EB lithography, a conductive polymer (polyisothianaphthene sulfonate) solution was coated on the coated resist film 1102. This solution was prepared by dispersing colloidal particles of the conductive polymer using a surfactant. After a conductive polymer 1103 was coated using the spin coater, the substrate was baked at 100° C. in an N₂ flow for 10 minutes for removal of the solvent.

### (Step 2) Formation of Openings by EB Lithography and Development: FIG. 11B

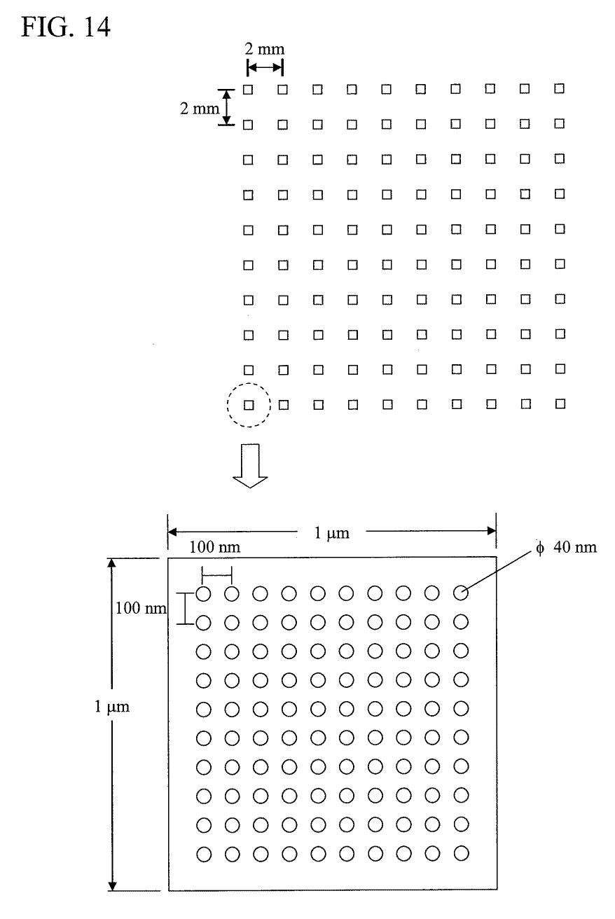

With an EB scanning field divided into 60,000 steps in the x- and y-directions, each step was irradiated with a pulsed EB having a spot size of approximately 2 nm to 3 nm. Upon designating the steps to be irradiated with the EB using CAD software, a desired pattern was formed. It is necessary that the size of the opening formed in the EB process is equivalent to the size of metal microparticle to be fixed. In this example, a gold nanoparticle having a particle size of 30 nm was used, since the nanoparticle of this size can be stably fixed on the EB opening and can provide the fluorescence enhancement effect. Therefore, the size of the EB opening was set to be 40 nm φ. The lithography pattern used in this example is shown in FIG. 14. The pattern consisted of EB irradiation areas each having a size of 40 nm φ arranged in a grid form at pitches of 100 nm. This lithography pattern was provided on an area of 1 μm square. One hundred of the processing areas having a size of 1 μm square were formed on the substrate. The processing areas were aligned in a grid form on the substrate at pitches of 2 mm.

The EB exposure method used in this example was based on an irradiation process in which a resist polymer main chain was cut by an energy gradually leaking out in radial fashion from the EB spot to the horizontal direction in the resist film while the EB was continuously irradiated to one spot.

EB lithography was performed with a field size of 150 μm square and an EB current of 5×10⁻¹¹ A.

A developing solution for dissolving a part of the resist polymer, in which the main chain thereof had been cut by the EB irradiation, was n-amyl acetate in this example. Since the conductive polymer is coated on the outermost surface of the substrate, the first process was to remove the polymer coating with pure water. Next, the substrate was immersed in the n-amyl acetate solution at 25° C. for 15 seconds for development, and then rinsed with a rinsing solvent consisting of 89% of methyl isobutyl ketone and 11% of isopropyl alcohol. In a series of these processes, an opening 1104 for fixing a gold nanoparticle of 40 nm φ was formed. The opening was confirmed in an electron microscopy.

### (Step 3) Formation of Amination Layer (Gold Microparticle Fixing Dot): FIG. 11C

The substrate having the EB resist opening pattern formed thereon was immersed into a 3-aminopropyltrimethoxysilane (APTMS) solution, which served as a silane coupling agent. The APTMS solution was prepared by diluting APTMS with methanol as the solvent. The reaction was carried out at room temperature for 5 minutes. The substrate after the reaction was thoroughly washed with methanol and dried. As a result of this process, the APTMS was adsorbed at the bottom of the opening. The substrate was then subjected to annealing at 80° C. for 2 hours. In this annealing process, a siloxane bond was formed between the APTMS and SiO₂ on the bottom of the opening, and thereby the bottom of the opening was stably aminated. Meanwhile, the APTMS was also adsorbed on the resist, causing the resist to have the residual APTMS.

### (Step 4) Fixation of Gold Nanoparticles: FIG. 11D

Next, the substrate having the bottom of the opening aminated was caused to interact with a citric acid solution containing gold nanoparticles 1106 with a size of 30 nm. The concentration of the gold nanoparticles 1106 was approximately 0.4 nM. The reaction was carried out at room temperature for 20 hours. At this point, having the surface covered with citric acid, the gold nanoparticle had a negative charge. Meanwhile, the aminated surface had a positive charge. Thus, due to the attraction between the gold nanoparticle and an amino group 1105 on the aminated surface, the gold nanoparticle 1106 was fixed thereon. After the reaction with the gold nanoparticle, the substrate was thoroughly washed with pure water and dried.

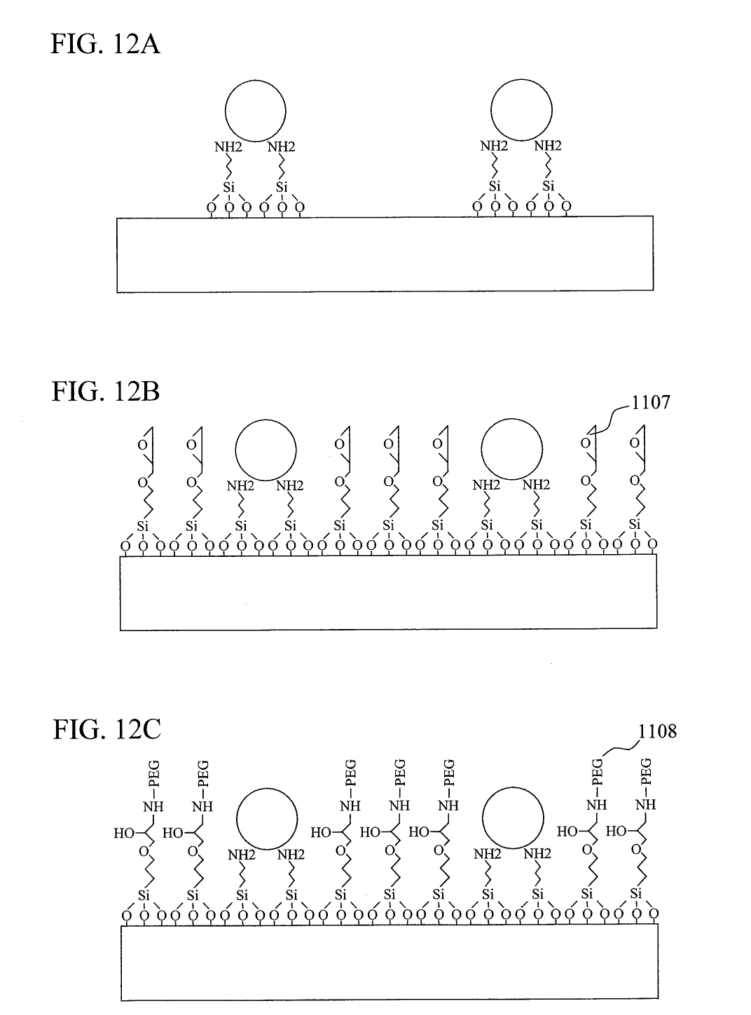

### (Step 5) Removal of Resist: FIG. 12A

The substrate was immersed in a dimethylacetamide solution for 3 minutes for removal of the resist. In this step, a sufficient amount of dimethylacetamide solution was used to prevent the gold nanoparticles on the resist from re-attaching to the substrate. After being immersed in the dimethylacetamide solution, the substrate was thoroughly washed with ethanol and pure water. In this step, the gold nanoparticles adsorbing on the resist were also lifted off, leaving only the gold nanoparticles fixed on the opening. The gold nanoparticles of 30 nm were successfully aligned in a grid form.

### (Step 6) Fixation of Adsorption Inhibitor Layer: FIG. 12B

After being immersed in ethanol and dried, the substrate having the gold nanoparticles of 30 nm aligned in a grid form thereon was modified with epoxy groups 1107. The epoxy groups were introduced on the region where no gold nanoparticle was fixed by subjecting the substrate to a reaction at 85° C. for 2 hours in a dehydrated toluene solution containing 0.8% of diisopropylethylamine and 7.7% of 3-glycidoxypropyltrimethoxysilane (GOPS). After the reaction, the substrate was washed with dehydrated toluene and ethanol, and dried.

### (Step 7) Fixation of PEG: FIG. 12C

The epoxy groups fixed on the substrate in Step 6 were caused to react with terminally aminated PEG (molecular weight: 2k) 1108 under a weak alkaline condition. To be more specific, aminated PEG was dissolved in a solution at a concentration of 4 mM, and the substrate was immersed in the 4 mM aminated PEG solution at room temperature for 1 hour. Then, the substrate was thoroughly washed with pure water and then dried. In this step, the region where no gold nanoparticle was fixed was blocked with the PEG 1108 as shown in FIG. 12C.

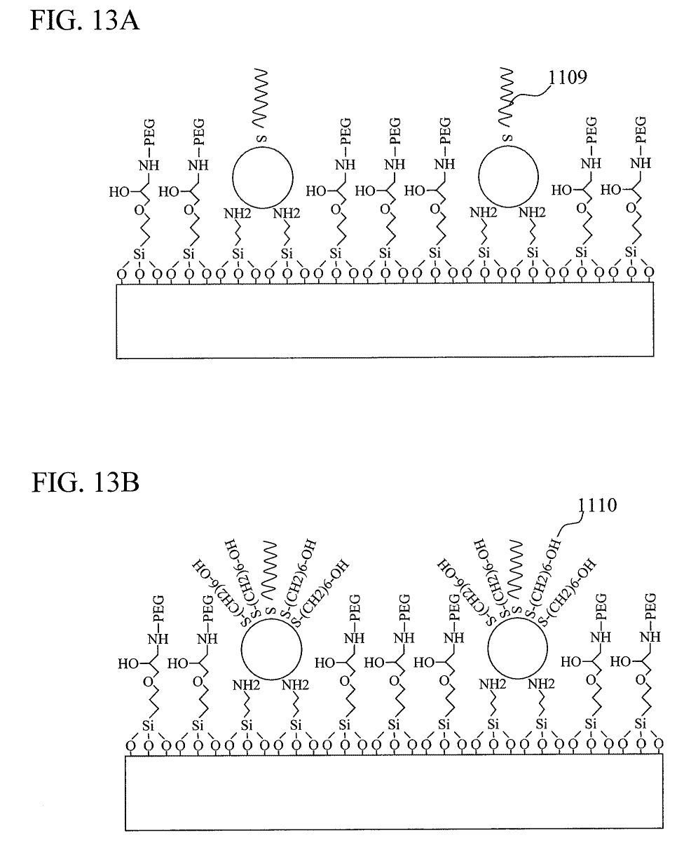

### (Step 8) Fixation of Single Probe DNAs: FIG. 13A

After the substrate provided with epoxy groups and PEG introduced thereon in Steps 6 and 7 was washed with ethanol, a solution containing terminally thiolated 50-mer single strand probe DNAs was spotted on each of the 1 μm square gold nanoparticle coated areas of the substrate surface. All single probe DNAs had the same nucleic acid sequence, and single-type probe DNAs 1109 were spotted on 100 areas. This was to examine variation in detection yield among the spots. The nucleic acid sequence of the probe DNA from the 5′ terminal to the 3′ terminal was as follows.

AGTCGAGCGGTAGCACAGAGAGCTTGCTCTCGGGTGACGAGCGGCGGACG

The probe DNA reaction solution used in this example was a 1M phosphate buffer (pH 6.7) containing 1 nM of 50-mer single strand DNA dissolved therein, the DNA having a thiol group at the 5′ terminal. This concentration was selected on the basis of the adsorption level evaluation experiment by the SPR method described in the step (8) in DESCRIPTION OF THE PREFERRED EMBODIMENT, and single molecule fixation was confirmed in a single molecule fluorescence measurement at this concentration. This probe DNA reaction solution and the gold nanoparticles aligned in a grid form were caused to react with each other at room temperature at 100% humidity for 24 hours. Then, the substrate was rinsed with a 2×SSC solution containing 0.1% of SDS (sodium dodecyl sulphate), washed twice with pure water, and then dried.

(Step 9) Blocking Step with Mercaptohexanol on the Gold Nanoparticle Surface: FIG. 13B

A mercaptohexanol solution of 0.1 μM was prepared, and the substrate having the probe DNAs fixed thereon was immersed in this solution. The reaction was carried out at room temperature for 1 hour. After the reaction, the substrate was washed with pure water, and dried under a reduced pressure in a desiccator to obtain a substrate on which the gold nanoparticle surface other than the portion thereof having the probe DNA fixed thereon was blocked with mercaptohexanol 1110 as shown in FIG. 13B.

### (Step 10) Hybridization

The substrate provided with the probe DNAs fixed thereon was subjected to hybridization with single-strand target DNAs which had a completely complementary sequence with that of the probe DNA and were labeled at the 5′ terminal with a fluorescent molecule Cy3. In a hybridization solution containing a mixture of 5×SSC and 0.5% SDS solution, the target DNA of 1 fmol was subjected to hybridization at 42° C. for 20 hours. Then, the substrate was washed with a 2×SSC solution containing 0.1% of SDS and with a 2×SSC solution, and then dried. An excitation light was applied to the dried substrate surface using a fluorescence scanner, and the fluorescence intensity from the surface was measured. The fluorescence intensity is proportional to the amount of target DNA reacted in the hybridization.

Meanwhile, a Si substrate having probe DNAs fixed thereon was prepared by a commonly-used conventional method for fixing single strand DNAs. The Si substrate was washed in the method described above (Step 1), and then coated with the silane coupling agent, APTMS, on the entire surface in the method described in Step 3 for amination of the substrate surface. Then, the amino group at the terminal was caused to react with PDC (phenylenediisothiocyanate) having an isothiocyanate group. A probe DNA having an amino group at the 5′ terminal was caused to react with the isothiocyanate group and thereby fixed. The probe DNA used in this step had the same DNA sequence shown in Step 8. The reaction solution used in the reaction of the probe DNA contained 1 μm of the probe DNA dissolved in a weak alkaline carbonate buffer. This solution was spotted on the substrate having isothiocyanate groups fixed thereon. The number of spots was 100, and the size of the spots was 200 μm φ. After being subjected to a reaction which was carried out at room temperature at 100% humidity for 24 hours, the substrate was rinsed with a 2×SSC solution containing 0.1% of SDS, washed twice with pure water, and then dried. After hybridization of the substrate with target DNAs having fluorescent molecules bound thereto in the method described in Step 10, the fluorescence intensity was measured. The obtained fluorescence intensity represents the amount of the hybridized target DNA.

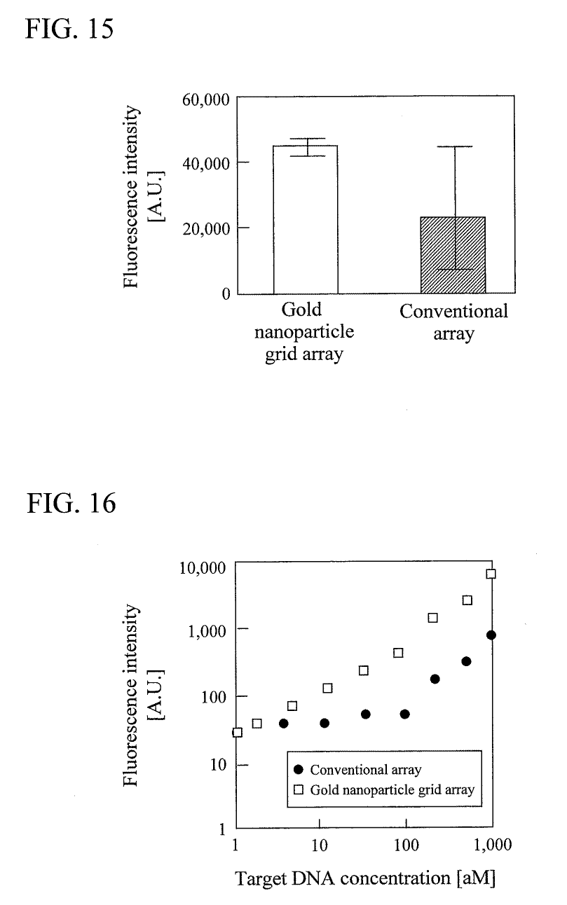

FIG. 15 shows the mean value and variation of fluorescence intensities in 100 grid array spots which were formed by aligning gold nanoparticles in a grid form and then by fixing single probe DNAs on the gold nanoparticles, as well as the mean value and variation of fluorescence intensities in 100 spots in the array on which probe DNAs were fixed by a conventional fixing method. An excitation light was applied to the surface using a fluorescence scanner, and the fluorescence intensity from the surface was measured. The excitation laser beam having a wavelength of 532 nm was used for scanning the spot areas, and generated fluorescence was detected using a photo multiplier tube.

The variation of fluorescence intensities was significantly reduced, from ±50% down to below ±5%, with the gold nanoparticle grid array of the present invention compared to the array prepared in the conventional method. This is because the individual probe DNAs, which are fixed separately from one another at pitches of 100 nm on the gold nanoparticle grid array of the present invention, are freely moving without interfering with one another, resulting in a uniform speed and efficiency of hybridization reaction with the target DNAs among the probe DNA and among the spots. In addition, the gold nanoparticle grid array of the present invention has a uniform fixing density of the probe DNAs, and shows no difference in the amount of supplied target DNA among positions. On the other hand, with a conventional substrate having a variation in fixing density of probe DNAs on the surface, there is an interference among the probe DNAs, and a variation in the amount of supplied target DNA is observed; thus, variations in speed and efficiency of hybridization reaction occur on the surface.

It was also found that the fluorescence intensity detected on the gold nanoparticle grid array of the present invention was stronger than that detected in the conventional array. The density of fixed probe DNAs was 100 molecules/μm² on the gold nanoparticle grid array. On the conventional array, on the other hand, the density of fixed probe DNAs measured by a measuring means, such as X-ray reflectometory, was approximately 5,000 molecules/μm², which was approximately 50 times higher than that on the gold nanoparticle grid array. Accordingly, on the basis of the fixing densities, the conventional array was supposed to be able to interact with a higher number of target DNAs, and therefore have a higher fluorescence intensity. However, as described above, having the probe DNAs isolated from one another, the gold nanoparticle grid array has a higher hybridization efficiency than that of the conventional array. Furthermore, the fluorescence was enhanced as shown in FIG. 15 due to the near-field effect in the vicinity of the gold nanoparticles. A double strand of 50-mer DNA has a length of approximately 17 nm. In the vicinity of the gold nanoparticles, the near-field light reaches from the nanoparticle surface to approximately the distance equivalent to the size of the nanoparticle. Thus, it can be assumed that fluorescence is enhanced in the region within a distance of 17 nm from the surface of the gold nanoparticle having a size of 30 nm. Due to the increase in the reaction efficiency and the fluorescence enhancement, having a lower DNA fixing density than that of the conventional-type array, the gold nanoparticle grid array rather exhibited a higher fluorescence intensity than that of the conventional-type array.

### Example 2

In order to measure a concentration detection limit of DNA microarray, a gold nanoparticle grid array having single probe DNAs fixed thereon was prepared in the same methods described in Steps 1 to 9 in Example 1. Meanwhile, a conventional array was prepared similarly in the method described in Example 1. Hybridization was performed in Step 10 described in Example 1.

In this example, the amount of completely complementary target DNAs having fluorescent molecules bound thereto in the hybridization was varied in a range from 1 amol to 1 fmol. The relationship between the fluorescence intensity and the amount of target DNAs was investigated for each array. The result suggested, as shown in FIG. 16, that the gold nanoparticle grid array had improved detection sensitivity for target DNA compared to the conventional array. While the detection limit of the conventional array was 100 amol, the detection limit of the gold nanoparticle grid array was 1 amol; thus, the sensitivity was largely improved. This was because the reaction efficiency of the isolated probe DNAs was improved and the fluorescence enhancement effect was obtained in the gold nanoparticle grid array of the present invention.

### Example 3

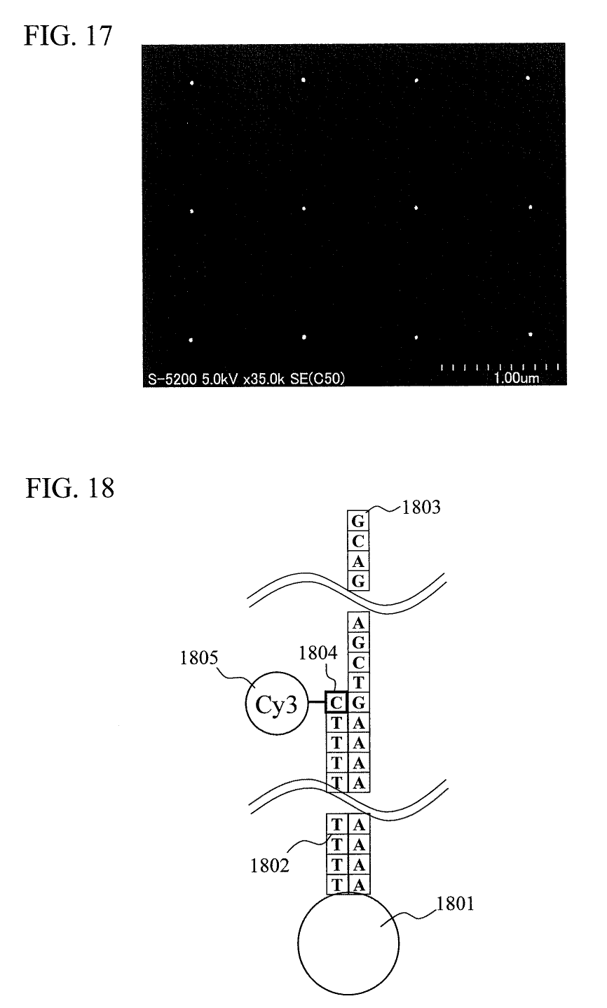

This example shows a case of using the present invention in DNA sequencing. A substrate for DNA sequencing was prepared according to Steps 1 to 8 described in Example 1 for the DNA sequencing. In this example, a quartz substrate was used in the place of the Si substrate. In the formation of openings by the EB lithography and development in Step 2, a pattern having openings of 40 nm φ arranged in a grid form at pitches of 1 μm was prepared. With this pattern, gold nanoparticles were aligned in the grid form at pitches of 1 μm. A scanning electron microscopic (SEM) observation result of the gold nanoparticle grid array substrate thus prepared is shown in FIG. 17. It was confirmed that the gold nanoparticles of 30 nm φ were aligned at pitches of 1 μm. Accordingly, if a CCD camera for detecting fluorescence intensity has a pixel size of 1 μm², it is possible to detect a fluorescence signal from one DNA molecule with one pixel in the sequencing process. A fluorescence signal from a single DNA molecule may be detected with, for example, 4 pixels or 9 pixels, upon increasing the number of pixels. In this example, the size of one pixel was set to be 1 μm². The probe DNA to be fixed in Step 8 used in this example was an oligonucleotide 1802 having a thiol group at the 3′ terminal and a sequence of 20 Ts (TTTTTTTTTTTTTTTTTTTT: 20-mer poly T) as shown in FIG. 18. In this case, the oligonucleotide was fixed by the bond between the thiol group at the end of the oligonucleotide and the gold nanoparticle.

Subsequently, DNA to be sequenced 1803 was hybridized with the probe DNA according to Step 10. To be more specific, the DNA (1803) having the following sequence including a poly A sequence at the 5′ terminal was hybridized as the DNA to be sequenced (see FIG. 18).

AAAAAAAAAAAAAAAAAAAAAGTCGAGCGGTAGCACAGAGAGCTTGCTCT
CGGGTGACGAGCGGCGGACG

Next, the DNA to be sequenced was subjected to sequencing with a primer having the 20-mer poly T sequence of the probe DNA. The gold nanoparticle grid array substrate prepared as described above and 4 kinds of nucleotides (1804) provided with a fluorescent label, Cy3 (1805), bound to the phosphate group of triphosphate of each nucleotide at the 3′ terminal thereof, were caused to react with each other using polymerase. The reaction solution used in the reaction contained 10 mM of Tris-HCl and 5 mM of MgCl₂. The concentration of the nucleotides was 1 μm. In the polymerase reaction, nucleotides having bases complementary to the nucleic acid sequence of the DNA were bonded to the DNA. In the present example, when the solution containing a nucleotide C dissolved therein and the substrate were subjected to the reaction, the nucleotide C was bonded to a nucleotide G located next to the poly A sequence within the sequence of the DNA to be sequenced. Fluorescence images in the process of polymerase reaction were obtained using the fluorescence detection system shown in FIG. 8. Fluorescence intensity was measured from the top of the substrate using a highly sensitive CCD camera. In the detection process, when an excitation light for fluorescent molecule was irradiated under total internal reflection conditions at the time of detection, a fluorescence signal was detected from a grid site where the nucleotide C (1804) having a fluorescent molecule was bound. When a nucleotide was bonded to the DNA, the phosphate group of the nucleotide incorporated by polymerase was detached. In this event, the fluorescent molecule bound to the terminal of the phosphate group was removed from the DNA to be sequenced. Next, when the solution containing a nucleotide A dissolved therein and the substrate were subjected to the reaction, the nucleotide A was bonded to a nucleotide T located next to the nucleotide G to which the nucleotide C was bonded in the previous reaction. When the bonding took place, fluorescence was detected. Next, when the solution containing a nucleotide T dissolved therein and the substrate were subjected to the reaction, no nucleotide T was bonded to the DNA. Since the DNA had a nucleotide C at the site available for the next bonding, and nucleotides C and T are not complementary, no nucleotide T could be bonded; therefore, no fluorescence was detected.

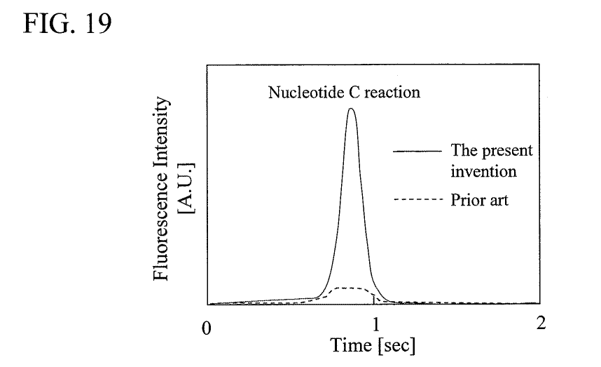

It was possible to determine a DNA sequence at each of the grids by repeating these processes. In other words, it was possible to detect each fluorescent signal from individual DNA fixing sites separately without signal interference from the surrounding site. And therefore it was possible to determine DNA sequences at all DNA fixing site without wasting any site as invalid grid. FIG. 19 shows the result of fluorescence detection performed on the hybridization status shown in FIG. 18. The detected fluorescence intensity was stronger than the fluorescence intensity measured in the conventional method. This was because the fluorescence intensity was enhanced by the fluorescence enhancement effect of the gold nanoparticle. Accordingly, it is possible to perform sequencing with higher sensitivity by using the sensor of the present invention. Alternatively, it is also possible to perform sequencing using a simple fluorescence detection system using the sensor of the present invention.

The present invention can be adopted in: DNA microarrays for quantitative analysis of DNAs and mRNAs; sequencing for determining DNA and mRNA sequences; and protein chips for protein analysis, and, furthermore, the present invention can be used as a pretreatment substrate which fixes proteins or carbohydrate chains to be sequenced before the sequencing.

What is claimed is:

1. A biomolecule sensor, comprising:
a carrier substrate; and
single probe molecules aligned and fixed respectively on grid points on the carrier substrate.

2. The biomolecule sensor according to claim 1, further comprising:
linker molecules fixed respectively on the grid points on the surface of the carrier substrate, and
metal microparticles bound respectively on the linker molecules, wherein
the single probe molecules are fixed respectively on the surfaces of the metal microparticles.

3. The biomolecule sensor according to claim 2, wherein the metal microparticles are made of any of a member of the noble metals, an alloy of the noble metals, and a laminate of the noble metals.

4. The biomolecule sensor according to claim 2, wherein the particle size of the metal microparticles is in a range from 0.6 nm to 1 μm inclusive.

5. The biomolecule sensor according to claim 2, wherein a region of the carrier substrate surface other than the portions having the metal microparticles fixed thereon is covered with adsorption inhibitors covalently fixed on the carrier substrate surface.

6. The biomolecule sensor according to claim 2, wherein a region of the metal microparticle surface other than the portion having the single probe molecule fixed thereon is covered with adsorption inhibitors.

7. The biomolecule sensor according to claim 2, wherein the ratio γ between a diameter, r1, of the metal microparticle and a diameter, r2, of the part where the linker molecule is fixed satisfies: 0.5≦γ≦1, where γ=r1/r2.

8. The biomolecule sensor according to claim 2, wherein the single probe molecule is composed of a nucleic acid.

9. A method for manufacturing a biomolecule sensor in which single probe molecules are aligned and fixed respectively on grid points on a carrier substrate, the method comprising the steps of:
fixing metal microparticles respectively on the grid points on the surface of the carrier substrate;
fixing adsorption inhibitors on the surface of the substrate; and
fixing the single probe molecules respectively on the surfaces of the metal microparticles.

10. The method for manufacturing a biomolecule sensor according to claim 9, further comprising the steps of:
fixing linker molecules respectively on the grid points on the substrate surface; and
binding the linker molecules respectively to the metal microparticle.

11. The method for manufacturing a biomolecule sensor according to claim 9, further comprising a step for fixing adsorption inhibitors on the surfaces of the metal microparticles.

12. A biomolecule detection method using a biomolecule sensor including: metal microparticles fixed respectively on grid points on a carrier substrate; and single probe molecules fixed respectively on the surfaces of the metal microparticles, the method comprising the steps of:
causing the probe molecule of the biomolecule sensor and a fluorescently labeled sample biomolecule to react with each other;
irradiating the biomolecule sensor after the reaction with an excitation light; and
detecting fluorescence emitted from the region having the probe molecule fixed thereon.

13. A biomolecule detection method for detecting a nucleic acid sequence using a biomolecule sensor including: metal microparticles fixed respectively on grid points on a carrier substrate; and single probe nucleic acid molecules fixed respectively on the surfaces of the metal microparticles, the method comprising the steps of:
causing the probe nucleic acid molecule of the biomolecule sensor and a nucleic acid molecule to be sequenced to react with each other;
causing the nucleic acid molecule to be sequenced and a fluorescently labeled nucleotide to react with each other;
irradiating the biomolecule sensor with an excitation light; and
detecting fluorescence emitted from the fluorescently labeled nucleotide.

14. A biomolecule detection system for detecting a nucleic acid sequence using a biomolecule sensor including: metal microparticles fixed respectively on grid points on a carrier substrate; and single probe nucleic acid molecules fixed respectively on the surfaces of the metal microparticles, the biomolecule detection system comprising:
a substrate serving as a platform for a reaction between the probe nucleic acid molecule of the biomolecule sensor and a nucleic acid molecule to be sequenced, and for a reaction between the nucleic acid molecule to be sequenced and a fluorescently labeled nucleotide;
an irradiation source for irradiating the biomolecule sensor with an excitation light; and
a detector for detecting fluorescence emitted from the fluorescently labeled nucleotide.
